(19) United States
(12) Patent Application Publication
(10) Pub. No.: US 2020/0341021 A1
(43) Pub. Date: Oct. 29, 2020

(54) DISPENSING DEVICE, DISPENSING APPARATUS AND METHOD USING SAME, AND INSPECTION APPARATUS AND METHOD

(71) Applicant: University of Yamanashi, Kofu-shi, Yamanashi (JP)

(72) Inventors: Yoshiaki UKITA, Yamanashi (JP); Shunya OKAMOTO, Yamanashi (JP)

(73) Assignee: University of Yamanashi, Kofu-shi, Yamanashi (JP)

(21) Appl. No.: 16/757,136

(22) PCT Filed: Oct. 23, 2018
(86) PCT No.: PCT/JP2018/039382

§ 371 Date: Apr. 17, 2020

(30) Foreign Application Priority Data
Oct. 23, 2017 (JP) 2017-204602

(51) Int. Cl. G01N 35/08; G01N 35/10

(52) U.S. Cl. CPC G01N 35/08; G01N 2035/1044; G01N 35/10

(57) ABSTRACT

A dispensing apparatus including;
a plurality of first accommodating units which are formed in communication with each other and which are configured to be able to divide and accommodate a fluid sample transferred by external force;
a plurality of second accommodating units each configured to accommodate the fluid sample which has been divided into the plurality of the first accommodating units; and
transfer means each configured to transfer the fluid sample, which has been accommodated in the plurality of the first accommodating units, to the second accommodating units.

### TECHNICAL FIELD

The present invention relates to a dispensing device, and a dispensing apparatus and method and a test apparatus and method using it.

### BACKGROUND ART

For the purpose of improving research and development efficiency in pharmaceuticals, there have been analyzed biomarkers which allow a human body condition to be objectively measured and evaluated. Environmental samples have also been analyzed for a water quality survey and a soil survey in, for example, environmental monitoring.

Recently, in order to aim at significantly decreasing amounts of samples and reagents, and speeding-up and automation of analytical steps in these analyses, there have been developed a variety of techniques using very compact biochemical analytical devices (microdevices) having a size of about several centimeters to about several millimeters called as Micro Total Analysis System (μTAS) (see, e.g., PTL 1).

### CITATION LIST

### Patent Literature

PTL 1 Japanese Patent Application Laid-Open (JP-A) No. 2017-75807

### SUMMARY OF INVENTION

### Technical Problem

When analyzing the biomarkers or the environmental samples, liquid serving as an analyte or a sample may need to be discharged from, for example, a pipette in a constant volume. This is called as a dispersing procedure. For example, when a plurality of reagents are used for testing one analyte, the dispersing procedure is repeated for the number of times obtained by multiplying the number of analytes by the number of reagents. Specifically, in the case where six analytes are tested simultaneously and four reagents are needed for testing one analyte, the dispensing procedure needs to be repeated twenty-four times. This is problematic because much time and effort are needed. There is a need to significantly decrease amounts of samples and reagents especially in the microdevices. However, it may be difficult for reagents in a minor amount to be dispensed.

The present invention can solve the above existing problems and achieve the following object. That is, the present invention has an object to provide a dispensing apparatus which can dispense a fluid sample in a homogeneous state even in a minor amount in synchronous to each other by means of a simple mechanism.

### Solution to Problem

A dispensing apparatus of the present invention includes
a plurality of first accommodating units which are formed in communication with each other and which are configured to be able to divide and accommodate a fluid sample transferred by external force;
a plurality of second accommodating units each configured to accommodate the fluid sample which has been divided into the plurality of the first accommodating units; and
transfer means each configured to transfer the fluid sample, which has been accommodated in the plurality of the first accommodating units, to the second accommodating units.

A dispensing method of the present invention includes
firstly accommodating a fluid sample in a plurality of first accommodating units which are formed in communication with each other and which are configured to be able to divide and accommodate the fluid sample transferred by external force;
secondly accommodating the fluid sample, which has been divided and accommodated in the plurality of the first accommodating units, in a plurality of second accommodating units each configured to accommodate the fluid sample; and
transferring the fluid sample, which has been accommodated in each of the plurality of the first accommodating units, to each of the second accommodating units.

A dispensing device of the present invention includes
an introduction unit configured to be introduced with a fluid sample;
a connected container including a plurality of dividing containers which are formed in communication with each other and which are configured to be able to divide and accommodate the fluid sample transferred by external force;
a group of accommodating containers including a plurality of accommodating containers each configured to accommodate the fluid sample which has been divided in the connected container; and
transfer mechanisms each configured to transfer the fluid sample, which has been accommodated and then divided in the connected container, to the group of accommodating containers.

A test apparatus of the present invention includes
a dispensing section including the dispensing apparatus of the present invention; and
a testing section configured to test a plurality of test objects using a fluid sample which has been dispensed by the dispensing section.

A test method of the present invention includes:
firstly accommodating a fluid sample in a plurality of first accommodating units which are formed in communication with each other and which are configured to be able to divide and accommodate the fluid sample transferred by external force;
secondly accommodating the fluid sample, which has been divided and accommodated in the plurality of the first accommodating units, in a plurality of second accommodating units each configured to accommodate the fluid sample;
transferring the fluid sample, which has been accommodated in each of the plurality of the first accommodating units, to each of the second accommodating units; and
testing a plurality of test objects using the fluid sample which has been accommodated in the second accommodating units.

### Advantageous Effects of the Invention

The present invention can provide a dispensing apparatus and a dispensing device which can dispense a fluid sample in a homogeneous state even in a minor amount in synchronous to each other by means of a simple mechanism; a dispensing method which allows a fluid sample to be dispensed in a homogeneous state even in a minor amount in synchronous to each other by means of a simple and convenient procedure; and a test apparatus and a test method using them.

### BRIEF DESCRIPTION OF DRAWINGS

FIG. 1 is a schematic top view illustrating one exemplary dispensing apparatus.

FIG. 2A is a schematic view illustrating a cross-sectional structure of the dispensing apparatus illustrated FIG. 1 taken through a L1-L1 line.

FIG. 2B is a schematic view illustrating a cross-sectional structure of the dispensing apparatus illustrated FIG. 1 taken through a L2-L2 line.

FIG. 3 is a schematic top view illustrating one exemplary state in which the dispensing apparatus illustrated FIG. 1 is placed on a disc-shaped driving apparatus.

FIG. 4 is a photograph of a dispensing apparatus of the present example.

FIG. 5 is a photograph of a disc-shaped driving apparatus on which a dispensing apparatus of the present example is placed.

FIG. 6A is a schematic view illustrating movement of a fluid sample A when dispensed from the dispensing apparatus illustrated FIG. 1.

FIG. 6B is a schematic view illustrating movement of a fluid sample A when dispensed from the dispensing apparatus illustrated FIG. 1.

FIG. 6C is a schematic view illustrating movement of a fluid sample A when dispensed from the dispensing apparatus illustrated FIG. 1.

FIG. 6D is a schematic view illustrating movement of a fluid sample A when dispensed from the dispensing apparatus illustrated FIG. 1.

FIG. 6E is a schematic view illustrating movement of a fluid sample A when dispensed from the dispensing apparatus illustrated FIG. 1.

FIG. 6F is a schematic view illustrating movement of a fluid sample A when dispensed from the dispensing apparatus illustrated FIG. 1.

FIG. 6G is a schematic view illustrating movement of a fluid sample A when dispensed from the dispensing apparatus illustrated FIG. 1.

FIG. 6H is a schematic view illustrating movement of a fluid sample A when dispensed from the dispensing apparatus illustrated FIG. 1.

FIG. 6I is a schematic view illustrating movement of a fluid sample A when dispensed from the dispensing apparatus illustrated FIG. 1.

FIG. 6J is a schematic view illustrating movement of a fluid sample A when dispensed from the dispensing apparatus illustrated FIG. 1.

FIG. 6K is a schematic view illustrating movement of a fluid sample A when dispensed from the dispensing apparatus illustrated FIG. 1.

FIG. 7A is a still image included in video data obtained by shooting movement of the fluid sample A when actually dispensed from the dispensing apparatus illustrated FIGS. 1 and 6A to 6K.

FIG. 7B is a still image included in video data obtained by shooting movement of the fluid sample A when actually dispensed from the dispensing apparatus illustrated FIGS. 1 and 6A to 6K.

FIG. 7C is a still image included in video data obtained by shooting movement of the fluid sample A when actually dispensed from the dispensing apparatus illustrated FIGS. 1 and 6A to 6K.

FIG. 7D is a still image included in video data obtained by shooting movement of the fluid sample A when actually dispensed from the dispensing apparatus illustrated FIGS. 1 and 6A to 6K.

FIG. 7E is a still image included in video data obtained by shooting movement of the fluid sample A when actually dispensed from the dispensing apparatus illustrated FIGS. 1 and 6A to 6K.

FIG. 7F is a still image included in video data obtained by shooting movement of the fluid sample A when actually dispensed from the dispensing apparatus illustrated FIGS. 1 and 6A to 6K.

FIG. 7G is a still image included in video data obtained by shooting movement of the fluid sample A when actually dispensed from the dispensing apparatus illustrated FIGS. 1 and 6A to 6K.

FIG. 7H is a still image included in video data obtained by shooting movement of the fluid sample A when actually dispensed from the dispensing apparatus illustrated FIGS. 1 and 6A to 6K.

FIG. 7I is a still image included in video data obtained by shooting movement of the fluid sample A when actually dispensed from the dispensing apparatus illustrated FIGS. 1 and 6A to 6K.

FIG. 7J is a still image included in video data obtained by shooting movement of the fluid sample A when actually dispensed from the dispensing apparatus illustrated FIGS. 1 and 6A to 6K.

FIG. 7K is a still image included in video data obtained by shooting movement of the fluid sample A when actually dispensed from the dispensing apparatus illustrated FIGS. 1 and 6A to 6K.

FIG. 8 is a graph illustrating results of coefficients of variation for amounts of the fluid sample dispensed from the dispensing apparatus illustrated in FIGS. 7A to 7K.

FIG. 9 is a diagram illustrating one exemplary dispensing apparatus without transfer means.

FIG. 10 is a still image included in video data obtained by shooting movement of the fluid sample A when actually dispensed from the dispensing apparatus illustrated FIG. 9.

FIG. 11 is a graph illustrating results of a coefficient of variation for amounts of the fluid sample dispensed from the dispensing apparatus illustrated in FIGS. 9 and 10.

FIG. 12 is a schematic top view illustrating one exemplary test apparatus used in an analytical processing for detecting a protein.

FIG. 13A is a schematic view illustrating movement of each fluid when a protein contained in a sample solution is tested by means of the test apparatus illustrated in FIG. 12.

FIG. 13B is a schematic view illustrating movement of each fluid when a protein contained in a sample solution is tested by means of the test apparatus illustrated in FIG. 12.

FIG. 13C is a schematic view illustrating movement of each fluid when a protein contained in a sample solution is tested by means of the test apparatus illustrated in FIG. 12.

FIG. 13D is a schematic view illustrating movement of each fluid when a protein contained in a sample solution is tested by means of the test apparatus illustrated in FIG. 12.

FIG. 13E is a schematic view illustrating movement of each fluid when a protein contained in a sample solution is tested by means of the test apparatus illustrated in FIG. 12.

FIG. 13F is a schematic view illustrating movement of each fluid when a protein contained in a sample solution is tested by means of the test apparatus illustrated in FIG. 12.

FIG. 13G is a schematic view illustrating movement of each fluid when a protein contained in a sample solution is tested by means of the test apparatus illustrated in FIG. 12.

FIG. 13H is a schematic view illustrating movement of each fluid when a protein contained in a sample solution is tested by means of the test apparatus illustrated in FIG. 12.

FIG. 13I is a schematic view illustrating movement of each fluid when a protein contained in a sample solution is tested by means of the test apparatus illustrated in FIG. 12.

FIG. 13J is a schematic view illustrating movement of each fluid when a protein contained in a sample solution is tested by means of the test apparatus illustrated in FIG. 12.

FIG. 13K is a schematic view illustrating movement of each fluid when a protein contained in a sample solution is tested by means of the test apparatus illustrated in FIG. 12.

FIG. 13L is a schematic view illustrating movement of each fluid when a protein contained in a sample solution is tested by means of the test apparatus illustrated in FIG. 12.

FIG. 13M is a schematic view illustrating movement of each fluid when a protein contained in a sample solution is tested by means of the test apparatus illustrated in FIG. 12.

FIG. 13N is a schematic view illustrating movement of each fluid when a protein contained in a sample solution is tested by means of the test apparatus illustrated in FIG. 12.

FIG. 13O is a schematic view illustrating movement of each fluid when a protein contained in a sample solution is tested by means of the test apparatus illustrated in FIG. 12.

FIG. 14A is a still image included in video data obtained by shooting movement of each fluid when the test apparatus illustrated FIGS. 12 and 13A to 13O actually performed a test.

FIG. 14B is a still image included in video data obtained by shooting movement of each fluid when the test apparatus illustrated FIGS. 12 and 13A to 13O actually performed a test.

FIG. 14C is a still image included in video data obtained by shooting movement of each fluid when the test apparatus illustrated FIGS. 12 and 13A to 13O actually performed a test.

FIG. 14D is a still image included in video data obtained by shooting movement of each fluid when the test apparatus illustrated FIGS. 12 and 13A to 13O actually performed a test.

FIG. 14E is a still image included in video data obtained by shooting movement of each fluid when the test apparatus illustrated FIGS. 12 and 13A to 13O actually performed a test.

FIG. 14F is a still image included in video data obtained by shooting movement of each fluid when the test apparatus illustrated FIGS. 12 and 13A to 13O actually performed a test.

FIG. 14G is a still image included in video data obtained by shooting movement of each fluid when the test apparatus illustrated FIGS. 12 and 13A to 13O actually performed a test.

FIG. 14H is a still image included in video data obtained by shooting movement of each fluid when the test apparatus illustrated FIGS. 12 and 13A to 13O actually performed a test.

FIG. 14I is a still image included in video data obtained by shooting movement of each fluid when the test apparatus illustrated FIGS. 12 and 13A to 13O actually performed a test.

FIG. 14J is a still image included in video data obtained by shooting movement of each fluid when the test apparatus illustrated FIGS. 12 and 13A to 13O actually performed a test.

FIG. 14K is a still image included in video data obtained by shooting movement of each fluid when the test apparatus illustrated FIGS. 12 and 13A to 13O actually performed a test.

FIG. 14L is a still image included in video data obtained by shooting movement of each fluid when the test apparatus illustrated FIGS. 12 and 13A to 13O actually performed a test.

FIG. 14M is a still image included in video data obtained by shooting movement of each fluid when the test apparatus illustrated FIGS. 12 and 13A to 13O actually performed a test.

FIG. 14N is a still image included in video data obtained by shooting movement of each fluid when the test apparatus illustrated FIGS. 12 and 13A to 13O actually performed a test.

FIG. 14O is a still image included in video data obtained by shooting movement of each fluid when the test apparatus illustrated FIGS. 12 and 13A to 13O actually performed a test.

FIG. 15 is a photograph illustrating a scanned image of a test apparatus which has been prepared for detection of a protein in the sequence of events as illustrated in FIGS. 14A to 14O.

FIG. 16 is a graph illustrating analysis results for amounts of the protein.

### DESCRIPTION OF EMBODIMENTS

### (Analytical Apparatus and Dispensing Method)

A dispensing apparatus of the present invention includes a plurality of first accommodating units, a plurality of second accommodating units, and transfer means; and, if necessary, further includes other means.

A dispensing method of the present invention includes a first accommodating step, a second accommodating step, and a transfer step; and, if necessary, further includes other steps.

The dispensing method of the present invention can be performed using the dispensing apparatus of the present invention. The first accommodating step can be performed using the plurality of the first accommodating units. The second accommodating step can be performed using the plurality of the second accommodating units. The transfer step can be performed using the transfer means. The other steps can be performed using the other means.

The dispensing apparatus of the present invention can dispense a fluid sample in a homogeneous state even in a minor amount in synchronous to each other by means of a simple mechanism.

The dispensing method of the present invention allows a fluid sample to be dispensed in a homogeneous state even in a minor amount in synchronous to each other by means of a simple and convenient procedure.

### <First Accommodating Step and Plurality of First Accommodating Units>

A first accommodating step is a step of dividing and individually accommodating a fluid sample transferred by external force, and is performed using a plurality of first accommodating units.

The plurality of the first accommodating units are not particularly limited and may be appropriately selected depending on the intended purpose, as long as they are formed in communication with each other and can divide and accommodate the fluid sample transferred by external force.

The plurality of the first accommodating units formed in communication with each other denote those formed so that the fluid sample can flow through upper portions of the plurality of the first accommodating units connected with each other and can accommodate the fluid sample with the entire serving as a single container.

The plurality of the first accommodating units are not particularly limited and may be appropriately selected depending on the intended purpose. However, the plurality of the first accommodating units preferably have volumes equal to each other. When the plurality of the first accommodating units have volumes equal to each other, the dispensing apparatus can dispense the fluid sample more equally by accommodating (filling) the fluid sample in the whole of the plurality of the first accommodating units and then accommodating the fluid sample in the second accommodating unit for each first accommodating unit.

A size, shape, structure, and number of the first accommodating units are not particularly limited and may be appropriately selected depending on the intended purpose, as long as the first accommodating units can accommodate the fluid sample. The number of the first accommodating units preferably depends on the number of samples to be dispensed.

Note that, the plurality of the first accommodating units may be hereinafter referred to as a “connected container,” the first accommodating unit may be hereinafter referred to as a “dividing container,” and the external force applied to the connected container may be hereinafter referred to as “external force A.”

The fluid sample is not particularly limited and may be appropriately selected depending on the intended purpose. Examples thereof include a solution containing, for example, blood, a protein, or a gene; a solution containing a solid component such as a microorganism, an animal cell, or a plant cell; and environmental water or soil extract containing various chemical substances. Additional examples of the fluid sample include various reagents, buffer solutions, and washing solutions used for analyzing the fluid sample.

The external force is not particularly limited and may be appropriately selected depending on the intended purpose. Examples thereof include centrifugal force, gravity, magnetic force, and pressing force.

Note that, when the external force is applied to the dispensing apparatus, force is generated which allows the fluid sample within the dispensing apparatus to flow into a chamber or a flow channel. An upstream side in a direction in which the external force is applied is hereinafter simply referred to as an “upstream side,” a portion corresponding to the upstream side in a direction in which the external force is applied in each unit is hereinafter referred to as an “upper portion,” a downstream side in a direction in which the external force is applied is hereinafter simply referred to as a “downstream side,” and a portion corresponding to the downstream side in a direction in which the external force is applied in each unit is hereinafter referred to as a “lower portion” or “bottom portion.”

Note that, the external force corresponds to all of external force A, external force B, and external force C described below.

When the external force is centrifugal force, force causing the fluid sample to flow may be generated by, for example, allowing a rotator on which a disk-shaped dispensing apparatus is placed to rotate to thereby apply the centrifugal force to the dispensing apparatus.

When the external force is gravity, force causing the fluid sample to flow may be generated by, for example, forming an elongated dispensing apparatus which can dispense the fluid sample through transfer of the fluid sample from one end to the other end and arranging the dispensing apparatus upon dispensing so that the one end is located above the other end.

When the external force is magnetic force, force causing a magnetic fluid sample to flow may be generated by, for example, arranging a north pole at the upstream side or a south pole at the downstream side of an analytical apparatus.

When the external force is pressing force, force causing the fluid sample to flow may be generated by, for example, pressing by means of, for example, an actuator a container which is filled with the fluid sample and which is mounted in an analytical apparatus.

### <Second Accommodating Step and Plurality of Second Accommodating Units>

A second accommodating step is a step of accommodating by external force each fluid sample divided in the connected container, and is performed using a plurality of second accommodating units.

The plurality of the second accommodating units are not particularly limited and may be appropriately selected depending on the intended purpose.

The plurality of the second accommodating units are not particularly limited and may be appropriately selected depending on the intended purpose, as long as they can accommodate by external force each fluid sample divided in the connected container.

A size, shape, structure, and number of the second accommodating units are not particularly limited and may be appropriately selected depending on the intended purpose, as long as the second accommodating units can accommodate the fluid sample. The number of the second accommodating units preferably depends on the number of the first accommodating units. The second accommodating units are preferably located at the downstream side of the first accommodating units.

Note that, the plurality of the second accommodating units may be hereinafter referred to as a “group of accommodating containers,” the second accommodating unit may be hereinafter referred to as an “accommodating container,” and the external force applied to the plurality of the second accommodating units may be hereinafter referred to as “external force B.”

### <Transfer Step and Transfer Means>

The transfer step is a step of transferring by the external force each fluid sample which has been divided in the first accommodating step in order to accommodate and dispense the fluid sample in the second accommodating step, after the fluid sample is filled in the first accommodating step. The transfer step is performed using transfer means.

The transfer means are not particularly limited and may be appropriately selected depending on the intended purpose, as long as they can transfer by the external force the fluid sample, which has been divided, to the group of accommodating containers, after the connected container is filled with the fluid sample. Note that, the transfer means may be hereinafter referred to as “transfer mechanisms,” and the external force applied to the transfer means may be hereinafter referred to as “external force C.”

The transfer means are configured to transfer the fluid sample contained in the connected container to the group of accommodating containers in synchronous to each other. The phrase “transfer in synchronous to each other” denotes that the transfer means transfer the fluid sample, which has been temporarily contained in the connected container, at the timing so that the fluid sample can be accommodated in all of the accommodating containers. That is, the transfer means only have to begin to transfer the fluid sample to one accommodating container at any time before the transfer means finish transferring the fluid sample from the connected container to another accommodating container. This allows the dispensing apparatus to dispense a single fluid sample contained in the connected container to the group of accommodating containers in a homogeneous state.

A method for synchronizing the transfer means is not particularly limited and may be appropriately selected depending on the intended purpose. For example, various sensors described below may be used to match the timing or a pressing flow channel and a flow channel provided with a siphon structure as described below may be used as the transfer method.

The transfer means may include a sensor configured to detect that the connected container is filled with the fluid sample and an electromagnetic valve configured to allow the fluid sample to flow out of the connected container into the group of accommodating containers based on a signal detected in the sensor.

In the case of an aspect without the sensor, flow channels may be simultaneously opened in synchronous to each other when the time has come that the connected container is filled with the fluid sample, for example, by using an electromagnetic valve with a timer. Examples of the sensor include a liquid pressure sensor, a liquid level sensor, and a flow rate sensor. The electromagnetic valve or the electromagnetic valve with a timer may be located at the bottom portion of each of dividing containers in the connected container. Examples of a power source for operating the sensor or the timer include a secondary battery and a solar battery.

In the case of an aspect without the need of the power source, for example, a mechanism including a pressing unit and a flow channel as described below may be used.

### «Pressing Unit and Flow Channel»

The pressing unit is not particularly limited and may be appropriately selected depending on the intended purpose, as long as it can apply pressure equal to or greater than the predetermined value to the fluid sample contained in the connected container.

The flow channel is not particularly limited and may be appropriately selected depending on the intended purpose, as long as, when the pressure equal to or greater than the predetermined value is applied to the fluid sample contained in the connected container, the fluid sample can be transferred from the connected container to the group of accommodating containers by the action of the applied pressure.

The pressure equal to or greater than the predetermined value denotes pressure at which, when this pressure is applied, the flow channel becomes unable to hold the fluid sample to thereby transfer the fluid sample.

Examples of the pressing unit include a pump and an actuator. From the viewpoint of the unnecessity of the power source for operating the pump or the actuator, a pressing flow channel which is connected to the upper portion of the connected container and arranged to extend to the upstream side of the connected container may be used. When the pressing unit is the pressing flow channel, the external force to the downstream side is applied to the fluid sample accommodated in the pressing flow channel. As a result, the fluid sample contained in the connected container which is located at the downstream side of the pressing flow channel may be pressed.

A shape of the pressing flow channel is not particularly limited and may be appropriately selected depending on the intended purpose. For example, the pressing flow channel may be columnar-shaped, but is preferably moderately thin in order to begin to press immediately after the completion of the first accommodating step.

Another example of the pressing unit includes one having a structure in which the fluid sample is flowed into a sealed container to thereby transfer a pressing medium, which is at least one of a liquid and a gas and is incompatible with the fluid sample, and then the fluid sample contained in the connected container is pressed by the action of pressure applied by the pressing medium.

The flow channel is not particularly limited and may be appropriately selected depending on the intended purpose, as long as, after pressure is applied by the pressing unit to the fluid sample contained in the connected container, the fluid sample can flow out of the connected container into the group of accommodating containers by the action of the pressure. Preferable is a flow channel which has a function as a valve openable/closeable by the pressure applied by the pressing unit. Examples of the flow channel which has a function as a valve include a flow channel having at least one of a siphon structure and a partial capillary tube structure.

Examples of the flow channel having the siphon structure include a flow channel having a hairpin-shaped bent portion at the upstream side. In such a case, if the group of accommodating containers is located at the downstream side of the connected container, the fluid sample flows out of the connected container based on the principle of siphon when pressure equal to or greater than pressure which allows the fluid sample to pass through the bent portion is applied to the fluid sample. Therefore, the flow channel works as the flow channel which has a function as a valve.

Examples of the flow channel having the partial capillary tube structure include a flow channel having a narrow portion which is thinner than others at a flow-out port at the downstream side of each of a plurality of containers. In such a case, the fluid sample is held at each narrow portion by the action of surface tension. However, when pressure equal to or greater than the surface tension is applied to the fluid sample, fluid sample flows out of the connected container. Therefore, the flow channel works as the flow channel which has a function as a valve.

The flow channel having a combination of the siphon structure and the partial capillary tube structure can hold the fluid sample even when applied with pressure greater than pressure at which the flow channel having the siphon structure or the partial capillary tube structure can hold the fluid sample.

When the pressing unit is the pressing flow channel and the flow channel is the flow channel having the siphon structure, pressure applied to the fluid sample contained in the connected container by the pressing flow channel is transmitted to all other portions of the fluid sample based on the principle of Pascal. Therefore, the pressure applied to the fluid sample by the pressing flow channel is uniformly applied to each flow channel having the siphon structure. As a result, the flow channels each having the siphon structure can transfer the fluid sample in synchronous to each other as long as the flow channels each having the siphon structure have the same structure as each other.

Therefore, the dispensing apparatus can transfer and dispense the fluid sample from each flow channel to the group of accommodating containers in synchronous to each other by applying the pressure equal to or greater than the predetermined value to the fluid sample contained in the connected container.

### <Other Means>

Examples of the other means include an introduction unit, a time adjustment means, and a vent.

The introduction unit is not particularly limited and may be appropriately selected depending on the intended purpose, as long as the fluid sample can be introduced and accommodated therein and can be transferred to the connected container by the external force.

The time adjustment mean is located between each unit and is configured to be able to prolong a time period for which the fluid sample passes through the flow channel by elongating a length or decreasing a diameter of the flow channel relative to a linear flow channel.

A shape of the time adjustment mean is not particularly limited and may be appropriately selected depending on the intended purpose. For example, the time adjustment mean may be zigzag or may have a siphon structure.

The vent is located at the upstream side of each unit in the dispensing apparatus and is open to the atmosphere. This allows to release the air within each unit when the fluid sample flows into each unit. Therefore, the fluid sample can be transferred smoothly.

A method for producing the dispensing apparatus is not particularly limited and may be appropriately selected depending on the intended purpose. Examples thereof include a lithographic technique, a method using a mold, and a method using a 3D printer. Units of the dispensing apparatus may be produced all at once or one by one using the method as described above.

A configuration of the dispensing apparatus is not particularly limited and may be appropriately selected depending on the intended purpose. For example, the connected container, the group of accommodating containers, and the transfer means may be integrated, at least one of the connected container, the group of accommodating containers, and the transfer means may be separated, or the connected container, the group of accommodating containers, and the transfer means may be separated from each other.

A shape of the dispensing apparatus is not particularly limited and may be appropriately selected depending on the intended purpose. When the external force is the centrifugal force, it is preferable that the dispensing apparatus can be placed on a rotatable rotator. For example, the dispensing apparatus may be plate-shaped, disk-shaped, or a shape formed by cutting off a disk by the predetermined angle from a center of a circle (so-called “fan-shaped”). As another example, the dispensing apparatus may be stick-shaped from the viewpoint of the possibility of use of a centrifuge.

A size of the disk-shaped dispensing apparatus may be similar to that of a compact disk (CD) or a digital video disk (DVD) from the viewpoint of handling by hand.

When the dispensing apparatus can be placed on a rotatable rotator, the centrifugal force as the external force can be efficiently applied to the dispensing apparatus.

The rotator is not particularly limited and may be appropriately selected depending on the intended purpose. For example, in the case where the dispensing apparatus is a disk-shaped disk, the rotator suitably has a mechanism for rotating the disk-shaped disk. The centrifugal force can be applied to the dispensing apparatus by rotating the rotator on which the dispensing apparatus is placed. The number of rotation of the rotator is not particularly limited and may be appropriately selected depending on the intended purpose. The number of rotation may be constant without the need of adjustment for increasing or decreasing the number of rotation, as long as it is the desired number of rotation.

Multiple dispensing procedures can be efficiently performed all at once by placing a plurality of dispensing apparatuses on the rotator.

Moreover, a dispensing apparatus and a test apparatus may be connected to each other and placed on the rotator. This allows a series of procedures from dispensing of a fluid sample to testing of test objects using the dispensed fluid sample to be automatically performed all at once. In this case, the test objects can be tested by the test apparatus using the dispensed fluid sample with the external force equal to the external force applied to the dispensing apparatus applied.

The rotator is controlled by a control means. The control means is not particularly limited and may be appropriately selected depending on the intended purpose, as long as it can control operation of the rotator using, for example, a motor. Examples thereof include equipment such as a sequencer and a computer. The motor is not particularly limited and may be appropriately selected depending on the intended purpose. The motor only has to steadily rotate.

The dispensing apparatus can dispense a fluid sample in a homogeneous state even in a minor amount in synchronous to each other by means of a simple mechanism of the connected container, the group of accommodating containers, and the transfer means.

### EXAMPLES

Example of the dispensing apparatus of the present invention will now be described with reference to drawings, but the present invention is not limited to the Example in any way.

### <Example of Dispensing Apparatus>

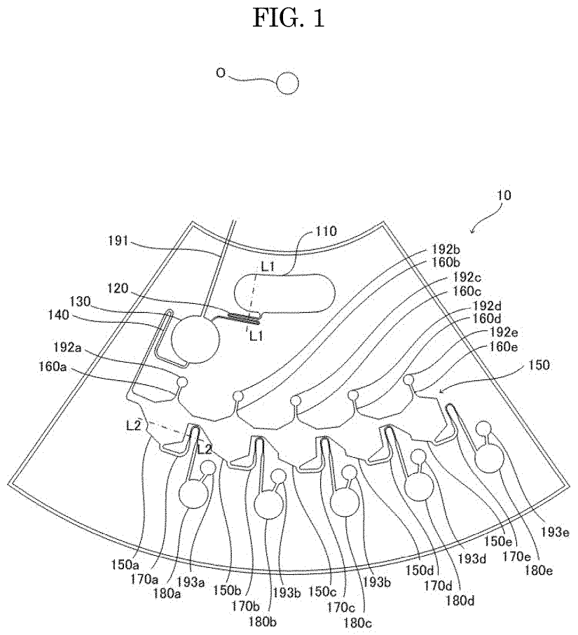

FIG. 1 is a schematic top view illustrating one exemplary dispensing apparatus 10.

As illustrated in FIG. 1, the dispensing apparatus 10 includes a first reservoir 110, a second reservoir 130, a connected chamber 150 serving as a connected container, pressing flow channels 160a to 160e serving as pressing units of transfer means, siphon-structured flow channels 170a to 170e serving as flow channels of transfer means, and accommodating chambers 180a to 180e serving as a group of accommodating containers.

A zig-zag bent flow channel 120 is located between the first reservoir 110 and the second reservoir 130. A siphon-structured flow channel 140 is located between the second reservoir 130 and the connected chamber 150.

Note that, the dispensing apparatus 10 rotates about a rotation axis position O and centrifugal force CF serving as external force is generated from the rotation axis position O as an originating point. Therefore, a side of each unit closer to the rotation axis position O is referred to as an upper portion or upstream and a side of each unit opposite to the rotation axis position O is referred to as a lower portion or downstream.

The first reservoir 110 is located at the most upstream of all units and accommodates a fluid sample A introduced by a user. When the centrifugal force is applied, the fluid sample A flows out of the first reservoir 110 into the second reservoir 130 through the bent flow channel 120 located at the downstream side.

The siphon-structured flow channel 140 is located downstream the second reservoir 130. A bent portion of the siphon-structured flow channel 140 is located above the second reservoir 130. Therefore, the fluid sample A is firstly measured in the second reservoir 130. Then, when the centrifugal force CF is applied and the fluid sample A, which has flowed out of the first reservoir 110, passes through the bent portion of the siphon-structured flow channel 140, the fluid sample A flows out of the second reservoir 130 into the connected chamber 150 through the siphon-structured flow channel 140 based on the principle of siphon.

The connected chamber 150 includes dividing chambers 150a to 150e serving as a plurality of first accommodating units which are formed in communication with each other and is configured to divide and accommodate the fluid sample A which has flowed out of the second reservoir 130. The dividing chambers 150a to 150e have volumes equal to each other and include pressing flow channels 160a to 160e at the upper portions thereof, respectively.

The pressing flow channels 160a to 160e are configured to accommodate the fluid sample A after the connected chamber 150 is filled with the fluid sample A which has flowed out of the second reservoir 130. Therefore, when the centrifugal force CF is applied, the centrifugal force CF is applied downward to the fluid sample accommodated in the pressing flow channels 160a to 160e to thereby press the fluid sample A contained in the connected chamber 150 which is located at the downstream side of the pressing flow channels 160a to 160e.

The siphon-structured flow channels 170a to 170e connect between the dividing chambers 150a to 150e of the connected chamber 150 located at the upstream side and the accommodating chambers 180a to 180e located at the downstream side, respectively. Bent portions of the siphon-structured flow channels 170a to 170e are located below communication portions of the connected chamber 150, but have a smaller diameter than others. Therefore, the fluid sample A can be accommodated in the connected chamber 150 to above the bent portions of the siphon-structured flow channels 170a to 170e even when the centrifugal force CF is applied. When the siphon-structured flow channels 170a to 170e are filled with the fluid sample A which has flowed out of the second reservoir 130 and, moreover, the fluid sample A is accommodated in the pressing flow channels 160a to 160e, the fluid sample A contained in the connected chamber 150 is pressed by the fluid sample A accommodated in the pressing flow channels 160a to 160e. As a result, meniscuses of the fluid sample A become over the bent portions of the siphon-structured flow channels 170a to 170e, and the fluid sample A contained in the connected chamber 150 is transferred to each of the accommodating chambers 180a to 180e based on the principle of siphon.

The accommodating chambers 180a to 180e each accommodates the fluid sample A divided into the dividing chambers 150a to 150e. Thus, a dispersing procedure of the fluid sample A is completed.

Note that, the dispensing apparatus 10 is provided with a vent 191, vents 192a to 192e, and vents 193a to 193e at the upstream side of each unit. This allows to release the air within each unit when the fluid sample flows into each unit. Therefore, the fluid sample can flow into each unit smoothly.

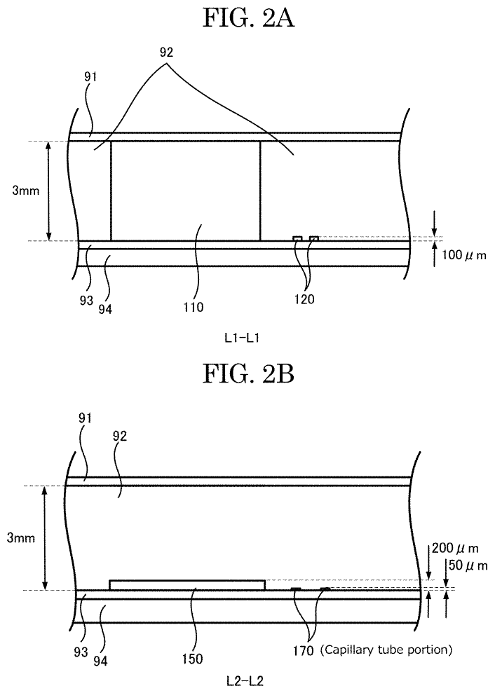

FIG. 2A is a schematic view illustrating a cross-sectional structure of the dispensing apparatus 10 illustrated FIG. 1 taken through a L1-L1 line and illustrates a cross-sectional structure of the first reservoir 110 and the bent flow channel 120 illustrated in FIG. 1.

As illustrated in FIG. 2A, the dispensing apparatus 10 has a layered configuration in which a polydimethylsiloxane (PDMS) sheet (PDMS sheet) 93, a PDMS layer 92, and a cover layer 91 on a base material portion 94 in this order. The PDMS layer 92 is processed by a lithographic technique to thereby form the first reservoir 110 and the bent flow channel 120. The first reservoir 110 has a processing depth of 3 mm which is the same as a thickness of the PDMS layer 92 and the bent flow channel 120 has a processing depth of 100 μm.

FIG. 2B is a schematic view illustrating a cross-sectional structure of the dispensing apparatus 10 illustrated FIG. 1 taken through a L2-L2 line and illustrates a cross-sectional structure of the connected chamber 150 and the siphon-structured flow channel 170 illustrated in FIG. 1.

As illustrated in FIG. 2B, the dispensing apparatus has a similar layered configuration to one illustrated in FIG. 2A in a cross section of the connected chamber 150 and the siphon-structured flow channel 170. The PDMS layer 92 is processed by the lithographic technique to thereby form the connected chamber 150 and the siphon-structured flow channels 170. The connected chamber 150 has a processing depth of 200 μm and the siphon-structured flow channel 170 has a processing depth of 50 μm in a thinner portion (capillary tube portion). Note that, the siphon-structured flow channel 170 has a processing depth of 100 μm in a thicker portion.

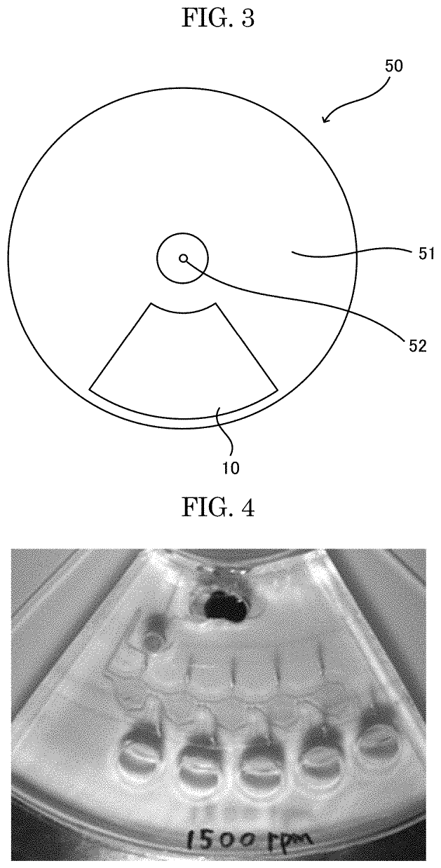

FIG. 3 is a schematic top view illustrating one exemplary state in which the dispensing apparatus 10 illustrated FIG. 1 is placed on a disc-shaped driving apparatus 50.

As illustrated in FIG. 3, the disc-shaped driving apparatus 50 includes a disc-shaped placing table 51 serving as a rotator and a plurality of dispensing apparatus 10 can be placed on the disc-shaped placing table 51. A hole 52 is provided at the center of the disc-shaped placing table 51 and a rotation axis of the disc-shaped driving apparatus 50 for rotating the disc-shaped placing table 51 is configured to be inserted into the hole 52. A position of the hole 52 corresponds to the rotation axis position O illustrated in FIG. 1.

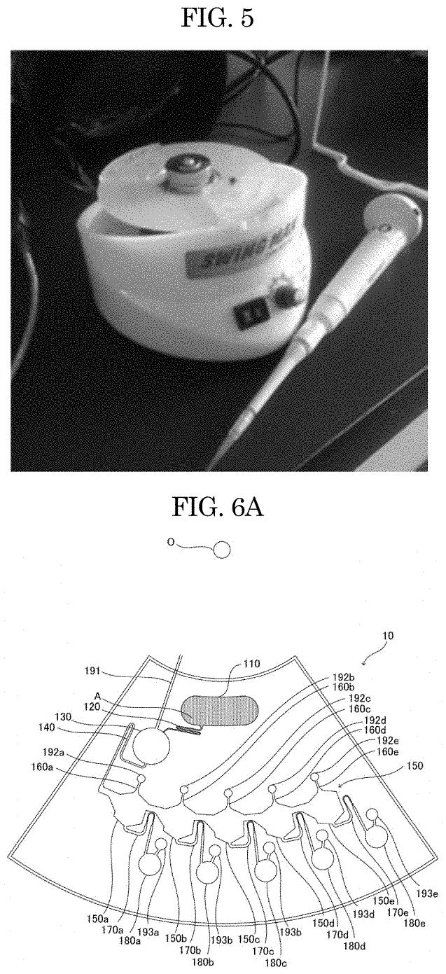

FIG. 4 is a photograph of the dispensing apparatus 10 of the present example. FIG. 5 is a photograph of a disc-shaped driving apparatus on which the dispensing apparatus 10 of the present example is placed.

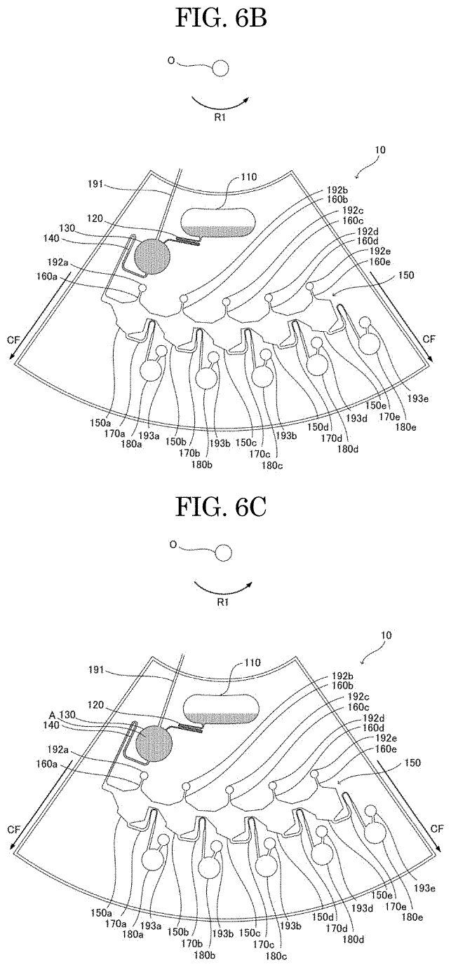

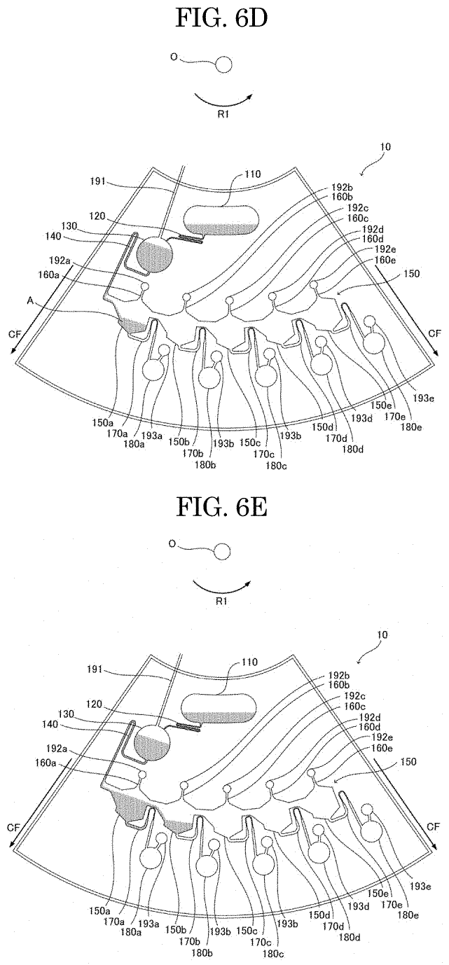

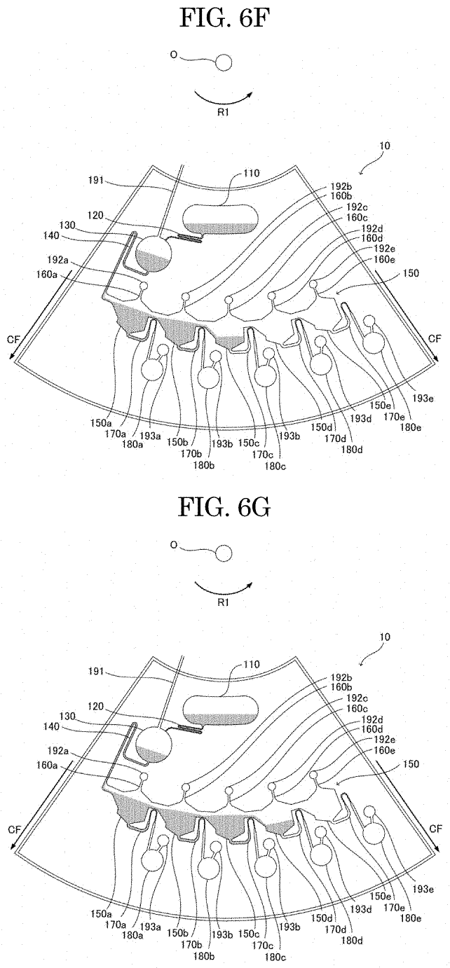

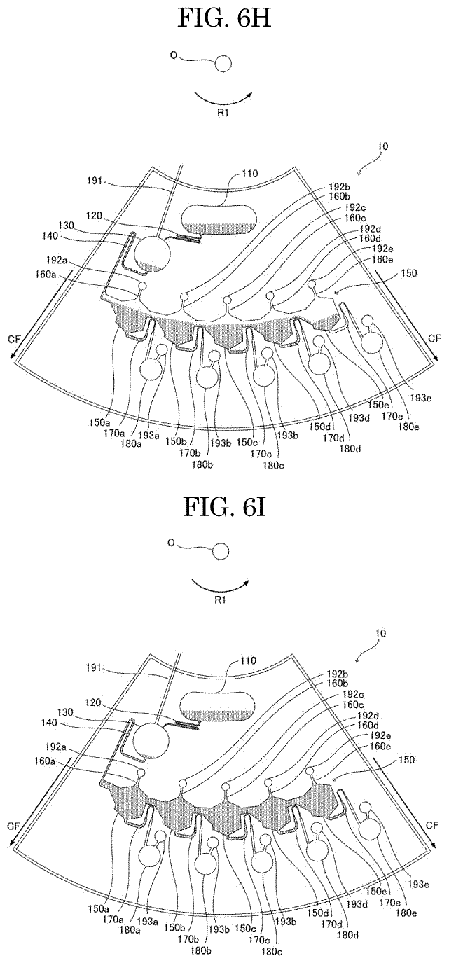

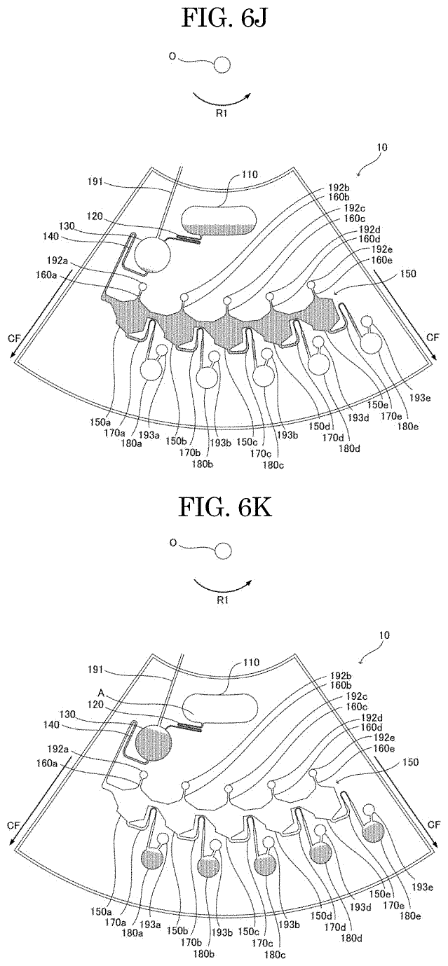

FIGS. 6A to 6K are schematic views illustrating movement of the fluid sample A when dispensed from the dispensing apparatus illustrated FIG. 1.

Firstly, as illustrated in FIG. 6A, 50 μL of a 0.2% Victoria blue-containing ion-exchanged water serving as the fluid sample A is introduced into the first reservoir 110 by a pipette.

Next, the dispensing apparatus 10 is placed on a disk 90 and fixed thereto (see FIG. 3). Then, the dispensing apparatus 10 is rotated at 1,500 rpm in a rotation direction R1 as illustrated in FIG. 6B to thereby apply the centrifugal force CF thereto. As a result, the fluid sample A flows into the second reservoir 130. At this time, the fluid sample A smoothly flows into the second reservoir 130 and reaches the siphon-structured flow channel 140 because the second reservoir 130 has the vent 191.

When the centrifugal force CF continues to be applied, the second reservoir 130 is filled up with the fluid sample A and the fluid sample A passes through the bent portion of the siphon-structured flow channel 140 as illustrated in FIG. 6C. Due to the principle of siphon and the fact that a flow rate at which the fluid sample A flows out of the second reservoir 130 is sufficiently higher than a flow rate at which the fluid sample A is flowed into the second reservoir 130, the fluid sample A having the almost same volume as a capacity of the second reservoir 130 flows into the connected chamber 150. As a result, as illustrated in FIGS. 6D to 6H, the fluid sample A is accommodated in the order from the dividing chamber 150a located at the left side to the dividing chamber 150e of the connected chamber 150. At this time, the fluid sample A reaches the siphon-structured flow channels 170a to 170e located at the downstream side of the connected chamber 150, but does not passes through the bent portions of the siphon-structured flow channels 170a to 170e yet.

When the centrifugal force CF further continues to be applied, as illustrated in FIG. 6I, the connected chamber 150 is filled up with the fluid sample A. At this time, the fluid sample A can smoothly flow into the pressing flow channels 160a to 160e because the vents 192 are provided at the other side of the pressing flow channels 160. The centrifugal force is applied to the fluid sample A flowed into the pressing flow channels 160a to 160e and, as a result, the fluid sample A flowed into the pressing flow channels 160a to 160e presses the fluid sample A contained in the connected chamber 150. Therefore, the fluid sample A within the siphon-structured flow channels 170a to 170e passes through the bent portions and flows into the accommodating chambers 180a to 180e (see FIG. 6J). When the fluid sample A passes through the bent portions of the siphon-structured flow channels 170a to 170e, the fluid sample A contained in the dividing chambers 150a to 150e instantaneously flows into the accommodating chambers 180a to 180e based on the principle of siphon (see FIG. 6K).

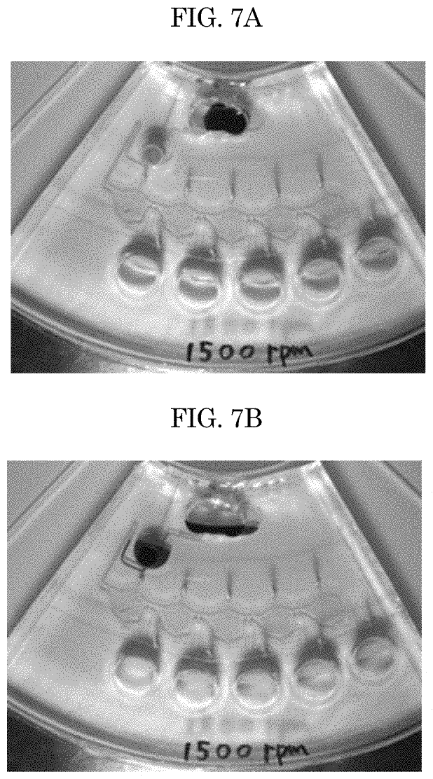

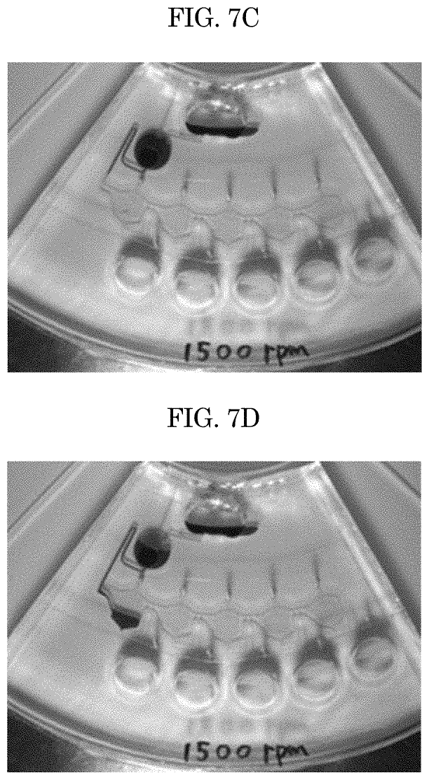

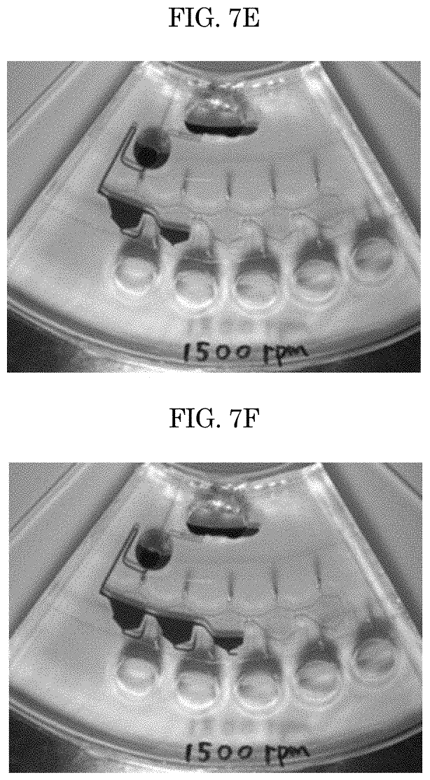

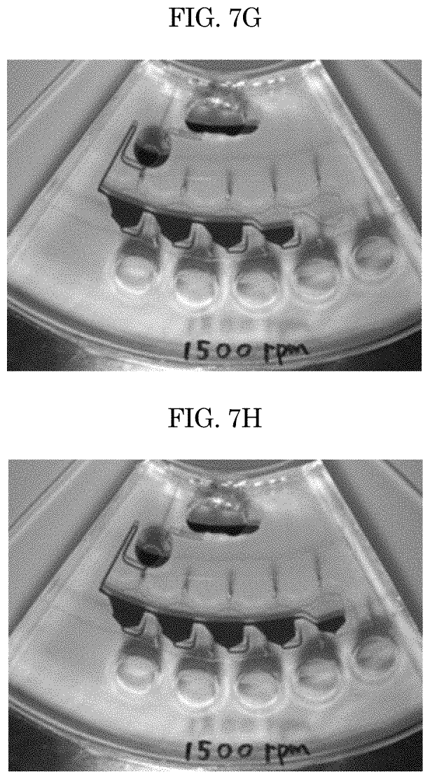

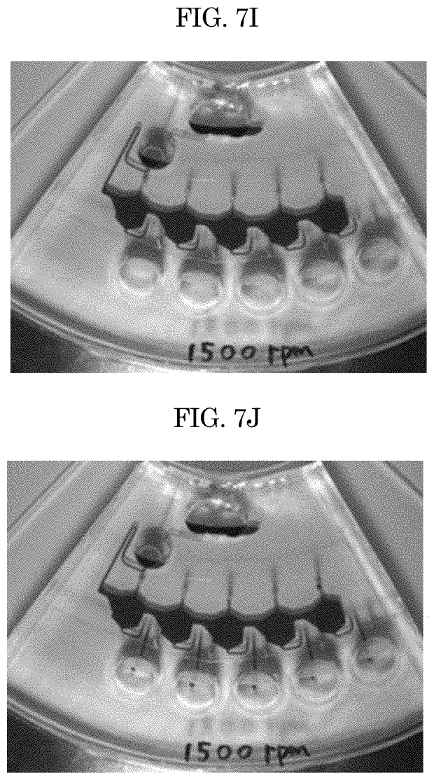

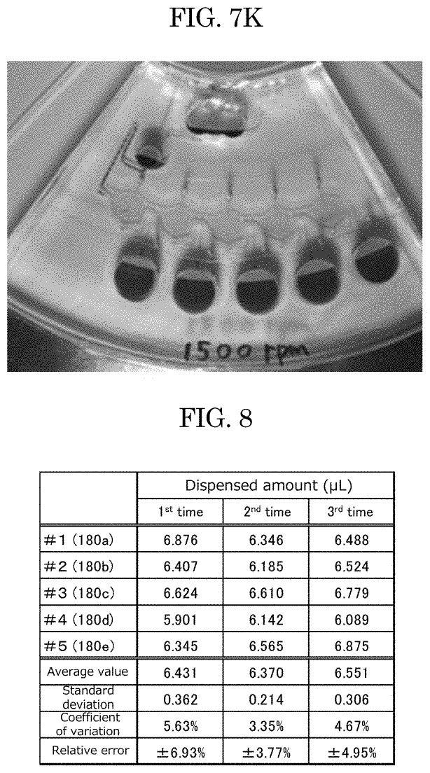

FIGS. 7A to 7K are still images included in video data obtained by shooting movement of the fluid sample A when actually dispensed from the dispensing apparatus illustrated FIGS. 1 and 6A to 6K. It can be seen from these results that the dispensing apparatus 10 can dispense a fluid sample in a homogeneous state even in a minor amount in synchronous to each other by means of a simple mechanism.

FIG. 8 is a graph illustrating results of coefficients of variation for amounts of the fluid sample A dispensed from the dispensing apparatus 50 illustrated in FIGS. 7A to 7K.

As illustrated in FIG. 8, the fluid sample A dispensed in the accommodating chambers 180a to 180e had the coefficients of variation CV of 3.3% to 5.6% when a dispensing procedure is performed for 3 times.

### <Comparative Example of Dispensing Apparatus>

A dispensing apparatus 20 without transfer means will now be described as Comparative example corresponding to the above-described Example.

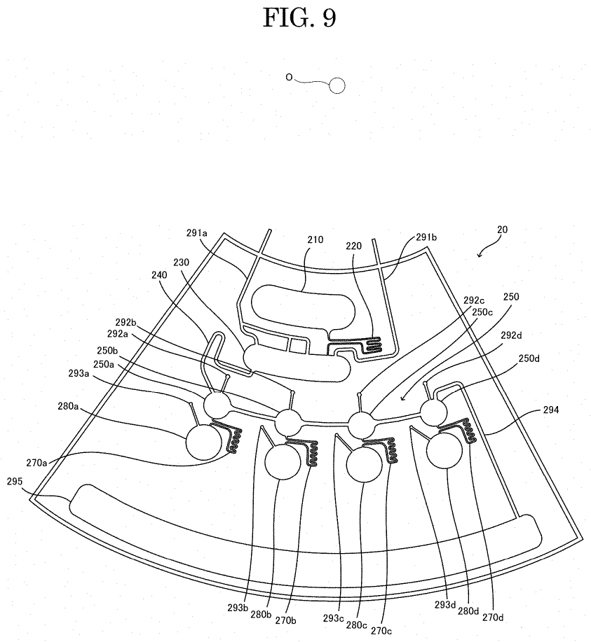

FIG. 9 is a diagram illustrating one exemplary dispensing apparatus 20 without transfer means.

As illustrated in FIG. 9, the dispensing apparatus 20 includes a first reservoir 210, a second reservoir 230, a connected chamber 250, and accommodating chambers 280.

The connected chamber 250 includes connected chamber 250a to 250d and is formed by allowing the connected chamber 250a to 250d to be in communication with each other. A group of accommodating chambers 280 includes accommodating chambers 280a to 280d. The connected chamber 250a to 250d are connected to accommodating chambers 280a to 280d via bent flow channels 270a to 270d, respectively.

A bent flow channel 220 is disposed between the first reservoir 210 and the second reservoir 230. A bent flow channel 240 is disposed between the second reservoir 230 and the connected chamber 250. The connected chamber 250a to 250d are connected to the vents 292a to 292d at the upstream side, respectively. The accommodating chambers 280a to 280d are also connected to the vents 293a to 293d at the upstream side, respectively.

Note that, the dispensing apparatus 20 was rotated about the rotation axis position O in the same manner as in the dispensing apparatus 10, except that the number of rotation was 1,200 rpm.

In the same manner as in the dispensing apparatus 10, 90 μL of a 0.2% Victoria blue-containing ion-exchanged water serving as the fluid sample A was introduced into the first reservoir 210 of the dispensing apparatus 20 by a pipette. Then, the dispensing apparatus 20 was rotated to thereby apply the centrifugal force thereto. Thus, the fluid sample A was dispensed into the accommodating chambers 280a to 280d.

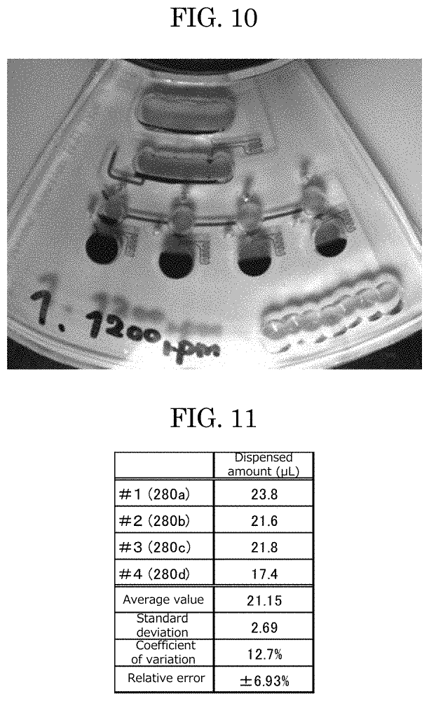

FIG. 10 is a still image included in video data obtained by shooting movement of the fluid sample A when actually dispensed from the dispensing apparatus 20 illustrated FIG. 9. As illustrated in FIG. 10, it can be seen that the dispensing apparatus 20 can easily dispense the fluid sample even in a minor amount.

FIG. 11 is a graph illustrating results of a coefficient of variation for amounts of the fluid sample dispensed from the dispensing apparatus 20 illustrated in FIGS. 9 and 10.

As illustrated in FIG. 11, the fluid sample A dispensed in the accommodating chambers 280a to 280e had the coefficient of variation CV of 12.7% when a dispensing procedure is performed once. When comparing with the coefficients of variation in the dispensing apparatus 10 equipped with siphon mechanisms illustrated in FIG. 8, it can be confirmed that the dispensing apparatus 10 equipped with siphon mechanisms is less variable for dispensed amounts.

Thus, the dispensing apparatus can dispense a fluid sample in a homogeneous state even in a minor amount in synchronous to each other by means of a simple mechanism composed of a plurality of first accommodating units (connected container), a plurality of second accommodating units (group of accommodating containers), and transfer means.

### (Test Method and Test Apparatus)

A test method of the present invention includes a dispensing step and a testing step; and, if necessary, further includes other steps.

A test apparatus of the present invention includes a dispensing section and a testing section; and, if necessary, further includes other sections.

The test method of the present invention can be performed using the test apparatus of the present invention, the dispensing step can be performed using the dispensing section, the testing step can be performed using the testing section, and the other steps can be performed using other sections.

### <Dispensing Step and Dispensing Section>

The dispensing step may be a dispensing step consisting of the dispensing method of the present invention of which detail has been described above.

The dispensing section may be a dispensing section consisting of the dispensing apparatus of which detail has been described above.

### <Testing Step and Testing Section>

The testing step is a step of testing dispensed objects which have been dispensed in the dispensing step and is performed using the testing section.

The testing section is not particularly limited and may be appropriately selected depending on the intended purpose, as long as it can test the dispensed objects. For example, a micro total analysis system (μTAS) in which, for example, a fine flow channel structure and a valve structure are integrated is suitably used.

The testing section is preferably configured to test the dispensed objects in the state in which the same external force as the external force applied to the dispensing section is applied thereto. This allows the test apparatus to continuously test the dispensed objects in the testing section after the dispensed objects are dispensed in the dispensing section.

A flow channel configured to transfer the dispensed objects dispensed in the dispensing section to the testing section is preferably disposed between the dispensing section and the testing section. Alternatively, the plurality of the second accommodating units in the dispensing apparatus may be used as the testing section.

### <Other Steps and Other Sections>

Examples of the other steps of the test method includes a control step.

Examples of the other sections of the test apparatus includes a control section.

The control section is not particularly limited and may be appropriately selected depending on the intended purpose, as long as it can control each section. Examples thereof include equipment such as a sequencer and a computer.

Thus, the test apparatus can easily test a plurality of test objects using the dispensing apparatus.

### (Dispensing Device)

A dispensing device of the present invention is a dispensing device used in any of the dispensing apparatus of the present invention and the test apparatus of the present invention.

The dispensing device includes an introduction unit, a connected container, a group of accommodating containers, and transfer mechanisms; and, if necessary, other units.

The introduction unit is not particularly limited and may be appropriately selected depending on the intended purpose, as long as a fluid sample can be introduced thereinto. Examples thereof include a fluid sample introduced container and a reservoir.

The connected container is not particularly limited and may be appropriately selected depending on the intended purpose, as long as it includes a plurality of dividing containers which are formed in communication with each other and which are configured to be able to divide and accommodate a fluid sample transferred by external force. For example, the connected container is similar to the plurality of the first accommodating units in the dispensing apparatus.

The group of accommodating containers is not particularly limited and may be appropriately selected depending on the intended purpose, as long as it includes a plurality of accommodating container each configured to accommodate the fluid sample divided in the connected container. For example, the group of accommodating containers is similar to the plurality of the second accommodating units in the dispensing apparatus.

The transfer mechanisms are not particularly limited and may be appropriately selected depending on the intended purpose, as long as, after the connected container is filled with the fluid sample, they can transfer the fluid sample, which has been divided, to the group of accommodating containers. For example, the transfer mechanisms are similar to the transfer means in the dispensing apparatus. The transfer mechanisms preferably each includes a pressing flow channel and a siphon-structured flow channel.

The pressing flow channel is not particularly limited and may be appropriately selected depending on the intended purpose, as long as it can apply pressure equal to or greater than the predetermined value to the fluid sample contained in the connected container. For example, the pressing flow channel is similar to the pressing unit in the dispensing apparatus.

The siphon-structured flow channel is not particularly limited and may be appropriately selected depending on the intended purpose, as long as, when the pressure equal to or greater than the predetermined value is applied to the fluid sample contained in the connected container, the pressure allows the fluid sample to flow out of the connected container into the group of accommodating containers. For example, the siphon-structured flow channel is similar to the flow channel in the dispensing apparatus.

The other sections are not particularly limited and may be appropriately selected depending on the intended purpose. Examples thereof include an introduction unit, a time adjustment means, and a vent, similar to in the dispensing apparatus.

The dispensing device is preferably a single-use disposable article which has the above-described configuration and is excellent in safety. The dispensing device may constitute the dispensing apparatus in combination with a driving apparatus in the form of a rotator or may constitute the test apparatus in combination with the testing section which configured to test the dispensed objects dispensed from the dispensing device.

Examples of a test apparatus of the present invention will now be described in detail with reference to drawings.

In the present example, a test apparatus used in an analytical processing for detecting a protein in an analyte will be described.

### <Example of Test Apparatus>

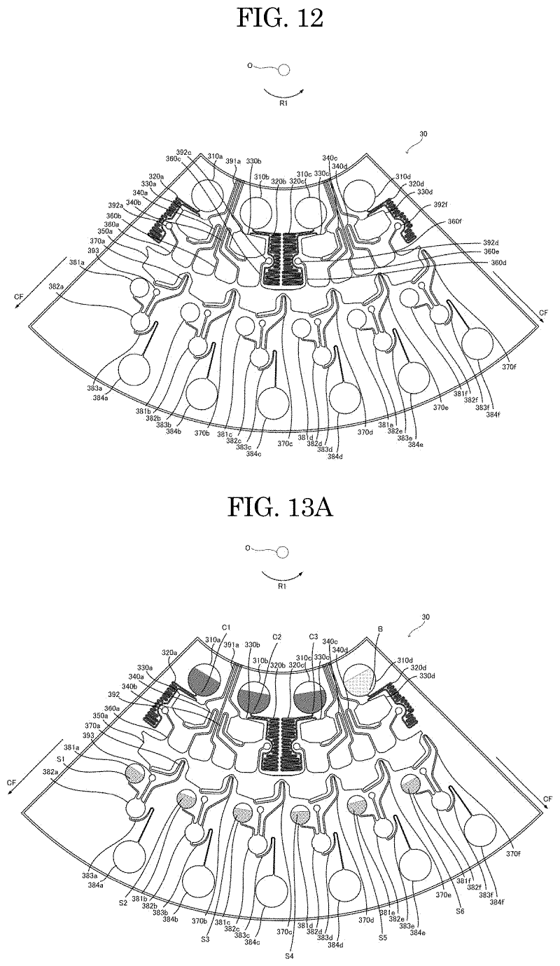

FIG. 12 is a schematic top view illustrating one exemplary test apparatus 30 used in an analytical processing for detecting a protein.

As illustrated in FIG. 12, the test apparatus 30 includes first reservoirs 310a to 310d, second reservoirs 330a to 330d, a connected chamber 350 serving as a connected container, pressing flow channels 360a to 360f serving as pressing units of transfer means, siphon-structured flow channels 370a to 370f serving as flow channels of transfer means, and reaction chambers 382a to 382f serving as a group of accommodating containers. The test apparatus 30 further includes sample introduced chambers 381a to 381f and waste fluid chambers 384a to 384f.

Bent flow channels 320a to 320d are disposed between the first reservoirs 310a to 310d and the second reservoirs 330a to 330d, respectively. Bent flow channels 340a to 340d are disposed between the second reservoirs 330a to 330d and the connected chamber 350, respectively. The siphon-structured flow channels 383a to 383d are disposed between the reaction chambers 382a to 382f and the waste fluid chambers 384a to 384f, respectively.

Note that, similar to in the dispensing apparatus 10, the test apparatus 30 rotates about a rotation axis position O and centrifugal force CF serving as the external force is generated from the rotation axis position O as an originating point. Therefore, a side of each unit closer to the rotation axis position O is referred to as an upper portion or upstream and a side of each unit opposite to the rotation axis position O is referred to as a lower portion or downstream.

The first reservoirs 310a to 310d are located at the most upstream of all units, 55 μL of each of washing solutions C1 to C3 (phosphate buffered saline: PBS) is introduced into each of the first reservoirs 310a to 310c, and 55 μL of a color developing substrate solution B (tetramethylbenzidine: TMBZ) is introduced into the first reservoir 310d.

Note that, the washing solutions C1 to C3 have a viscosity lower than that of the color developing substrate solution B. Specifically, the washing solutions C1 to C3 have the viscosity of 0.99 mPa·s and the color developing substrate solution B has the viscosity of 2.03 mPa·s.

A length and diameter of the bent flow channels 320a to 320d are adjusted taking viscosities of the solutions into account so that, when centrifugal force CF is applied, the washing solution C1, the washing solution C2, the washing solution C3, and the color developing substrate solution B flow out of the first reservoirs 310a to 310d into the second reservoirs 330a to 330d which are located downstream in this order and so that the subsequent solution begins to flow out after the previous solution is completely dispensed from the connected chamber 350 which is located further downstream.

The second reservoirs 330a to 330d are configured to accommodate the washing solutions C1 to C3 and the color developing substrate solution B which are flowed thereinto at the timing adjusted by the bent flow channels 320a to 320d when the centrifugal force CF is applied. The second reservoirs 330a to 330d allow the washing solutions C1 to C3 and the color developing substrate solution B contained therein to sequentially flow into the connected chamber 350 through the bent flow channels 340a to 340d.

Similar to the connected chamber 150, the connected chamber 350 includes dividing chambers 350a to 350f serving as the plurality of the first accommodating units formed in communication with each other. The connected chamber 350 is configured to divide and accommodate the washing solutions C1, the washing solutions C2, the washing solutions C3, and the color developing substrate solution B in this order, the solutions being flowed thereinto at the timing adjusted by the bent flow channels 320a to 320d when the centrifugal force CF is applied. The dividing chambers 350a to 350f have volumes equal to each other and include pressing flow channels 360a to 360f at the upper portions thereof, respectively.

Similar to the siphon-structured flow channels 170a to 170e, the siphon-structured flow channels 370a to 370f allow the washing solution C1, the washing solution C2, the washing solution C3, and the color developing substrate solution B, which are contained in the connected chamber 350, to flow into the reaction chambers 382a to 382f in this order based on the principle of siphon.

The sample introduced chambers 381a to 381f are configured to introduce and accommodate a sample solution and are located at the upstream side of the reaction chambers 382a to 382f. The sample introduced chambers 381a to 381f are configured to allow the sample solution to flow into the reaction chambers 382a to 382f immediately after the centrifugal force CF is applied.

The reaction chambers 382a to 382f are connected to the connected chamber 350 and the sample introduced chambers 381a to 381f at the upstream side and connected to the waste fluid chambers 384a to 384f at the downstream side, respectively.

Within the reaction chambers 382a to 382f, an antibody for capture was immobilized in advance and a labeled antibody for detection is applied thereto. The labeled antibody for detection denotes an antibody labeled with an enzyme or a fluorescent dye. In the present example, HRP (Horse Radish Peroxidase) was used.

Note that, in the present example, the antibody was immobilized within the reaction chambers, but is not limited thereto. Objects such as microbeads to which an antibody has been immobilized and which has been subjected to a blocking treatment may be arranged in the reaction chambers. The antibody is not particularly limited and may be appropriately selected depending on the intended purpose. For example, the same antibody may be immobilized within each reaction chamber or different antibodies may be immobilized for each reaction chamber.

The waste fluid chambers 384a to 384f are located the most downstream side and are configured to accommodate waste fluids flowed out of the reaction chambers 382a to 382f.

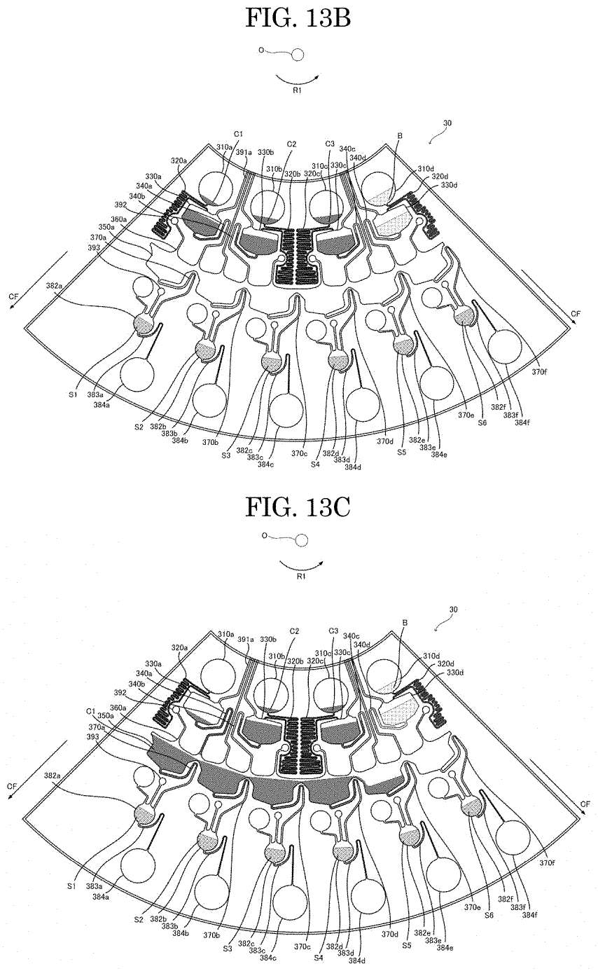

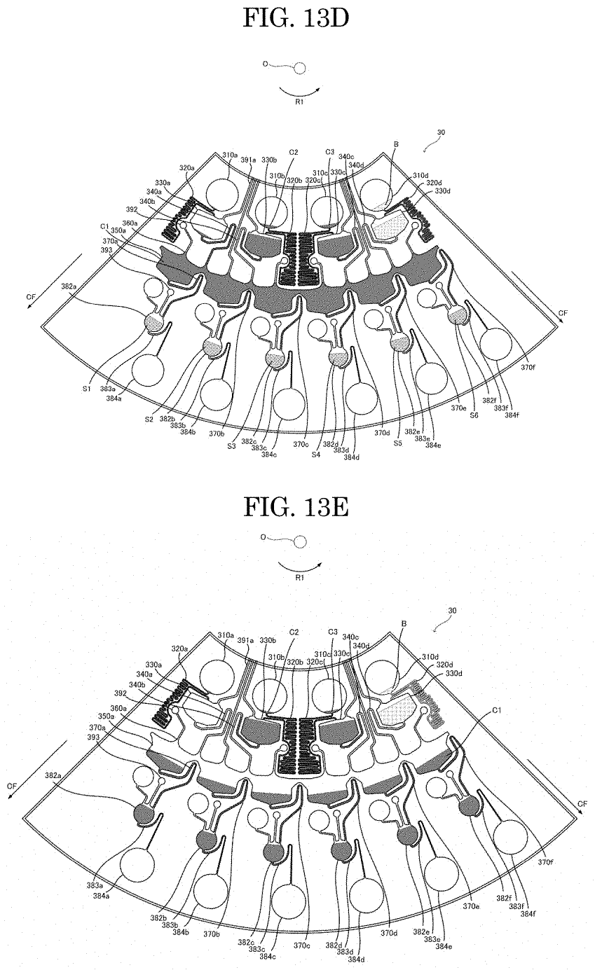

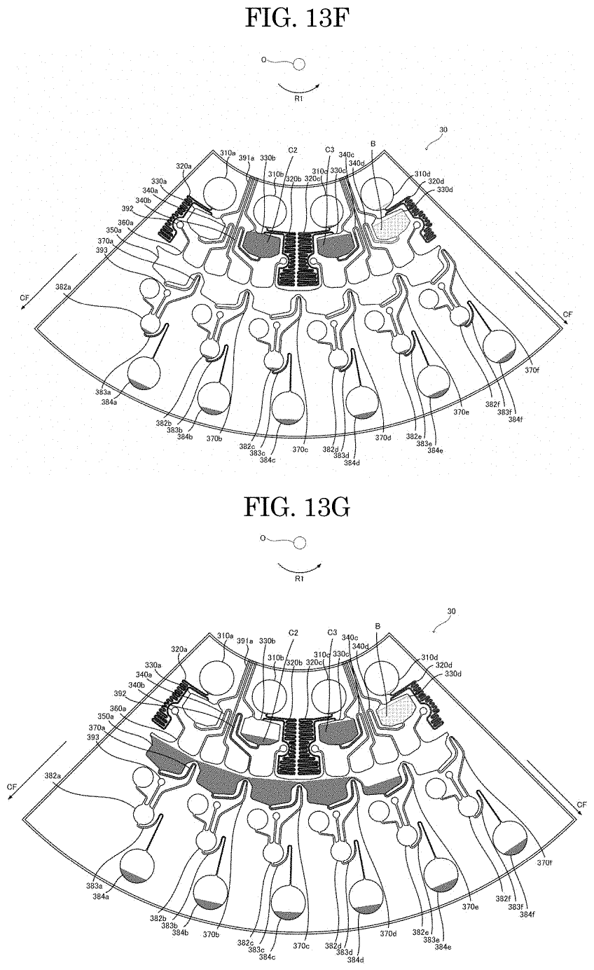

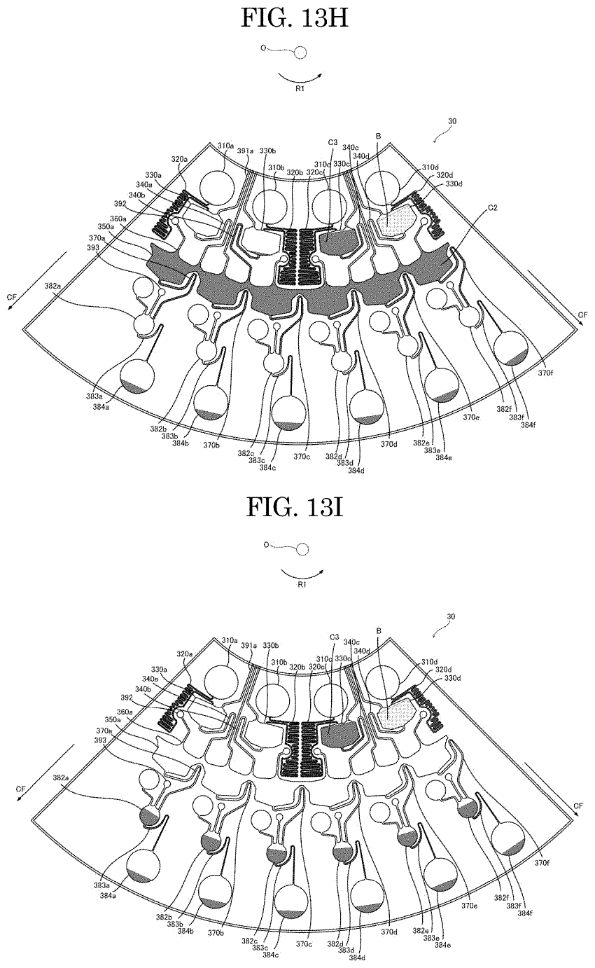

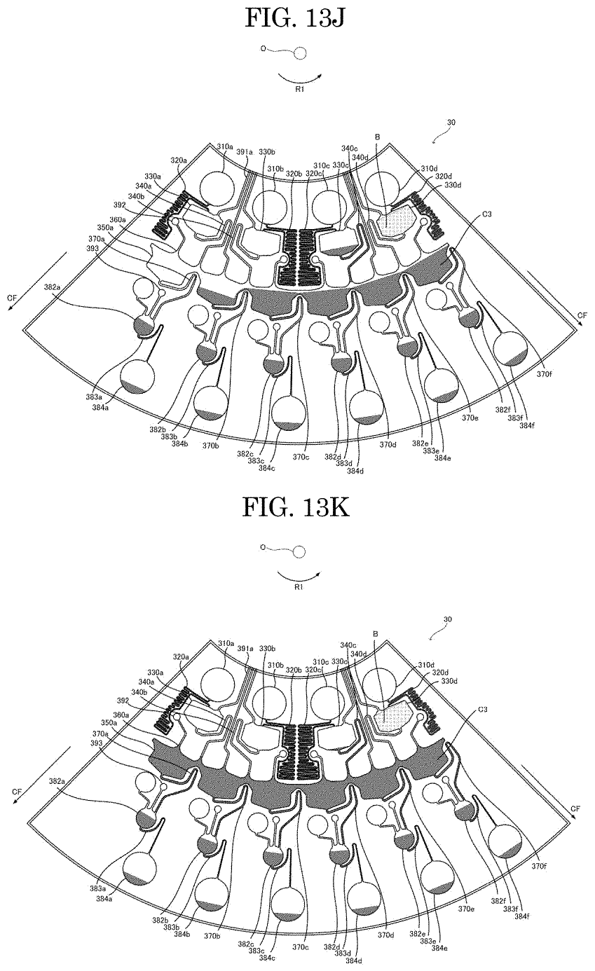

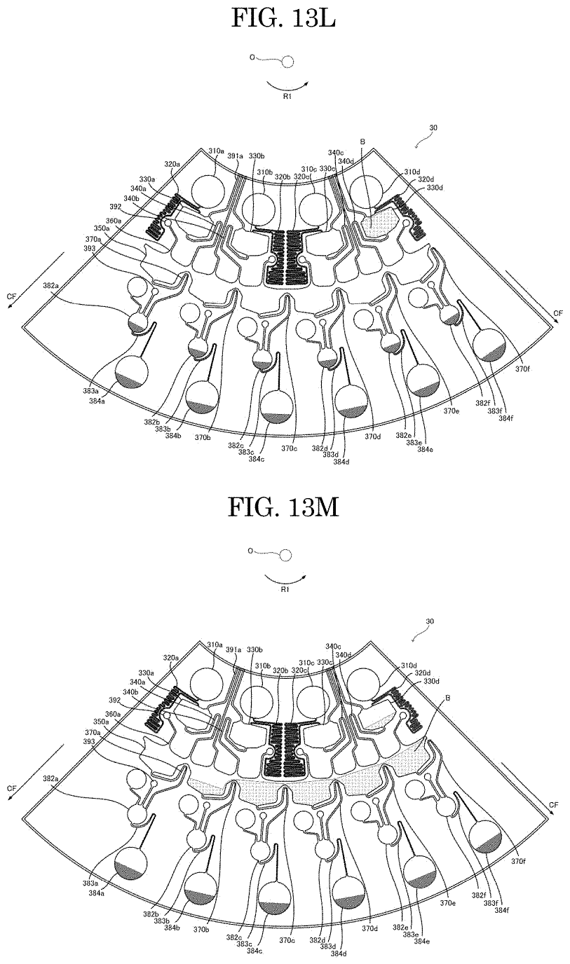

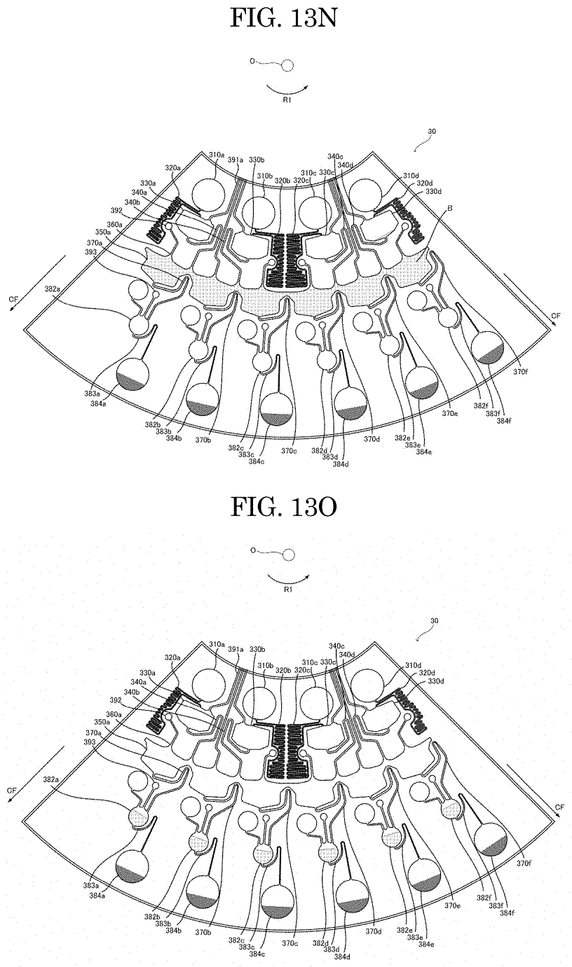

FIGS. 13A to 13O are schematic views illustrating movement of each fluid when a protein contained in sample solutions S1 to S6 is tested by means of the test apparatus 30 illustrated in FIG. 12.

First, as illustrated in FIG. 13A, 74 μL of rat IgG serving as the sample solutions S1 to S6 was introduced into the sample introduced chambers 381a to 381f by a pipette. Note that, the sample solutions S1 to S6 was introduced in a volume sufficient but equal to or less than the capacity of the reaction chambers 382a to 382f.

In the present example, the sample solutions S1 to S6 were formed by mixing an antibody for detection (HRP-labeled anti-rat IgG antibody) and an antigen (rat IgG) which had been prepared at any concentration.

Next, similar to the dispensing apparatus 10 in FIG. 3, the test apparatus 30 is placed on the disk 90 and fixed thereto. Then, the dispensing apparatus 30 is rotated at 1,500 rpm in a rotation direction R1 as illustrated in FIG. 12 to thereby apply the centrifugal force CF thereto. As a result, the sample solutions S1 to S6 flow into the reaction chambers 382a to 382f. At this time, the sample solutions S1 to S6 smoothly flow into the reaction chambers 382a to 382f because the reaction chambers 382a to 382f have the vents 393.

When the centrifugal force CF was applied, the sample solutions S1 to S6 flow into the reaction chambers 382a to 382f, respectively. As a result, an immunoreaction is incubated to thereby form an immunoconjugate. The immunoreaction is incubated until the washing solution C1 begins to flow into the reaction chambers 382a to 382f.

Next, the washing solutions C1 to C3 sequentially flow into the reaction chambers 382a to 382f to thereby wash out the sample solutions S1 to S6 and clean the reaction chambers 382a to 382f.

The sum of a volume of the washing solution C1 and a volume of each of the sample solutions S1 to S6 within each of the reaction chambers 382a to 382f was set to be equal to or more than a volume of each of the reaction chambers 382a to 382f. Therefore, when the washing solution C1 and sample solutions B are mixed in the reaction chambers 382a to 382f, the resultant mixed solutions are discharged from the reaction chambers 382a to 382f by the action of the siphon-structured flow channels 383a to 383d connected downstream the reaction chambers 382a to 382f to thereby remove, for example, an unbound labeled antibody.

Next, the washing solution C2 is dispensed into the connected chamber 350 and then is poured into the reaction chambers 382a to 382f. At this volume, the washing solution C2 is held within the reaction chambers 382a to 382f because a liquid level of the washing solution C2 does not reach the bent portion of a siphon. Subsequently, when the washing solution C3 is dispensed into the connected chamber 350 and then flows into the reaction chambers 382a to 382f, the sum of this volume and the volume of the washing solution 2 within each of the reaction chambers 382a to 382f become equal to or more than the volume of each of the reaction chambers 382a to 382f. Therefore, when the washing solution C1 and sample solutions B are mixed in the reaction chambers 382a to 382f, the resultant mixed solutions are discharged from the reaction chambers 382a to 382f by the action of the siphon-structured flow channels 383a to 383d connected downstream the reaction chambers 382a to 382f to thereby remove, for example, an unbound labeled antibody.

Next, when the color developing substrate solution B is dispensed into the connected chamber 350 and flows into the reaction chambers 382a to 382f, a reaction product of a test substance, the antibody for capture, and the labeled antibody for detection immobilized on the reaction chambers 382a to 382f causes color development. As a result, a color signal is obtained depending on an amount of the immunoconjugate. That is, the higher a concentration of a protein is, the bluer a color developing substrate develops. After the predetermined time, scanning for image analysis is performed in the state the TMBZ develops a blue color. Then, the TMBZ is removed and mixed with 1 M (mol/L) sulfuric acid H₂SO₄ at a ratio of 1:1 to thereby stop the color development reaction. The degree of color development is measured with a plate reader in the state in which the color development has been stopped. Image analysis date and absorbance values obtained from these measurements are plotted and a standard curve of the test substance is generated.

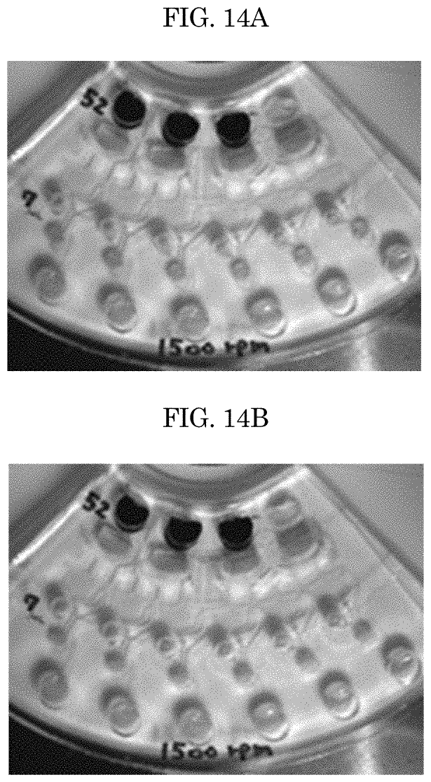

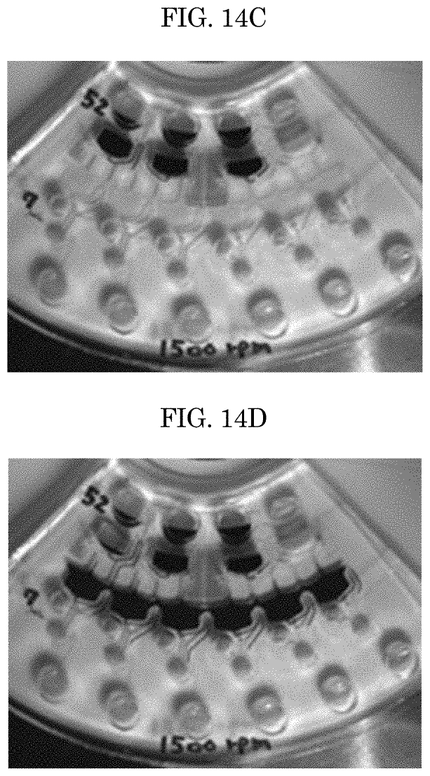

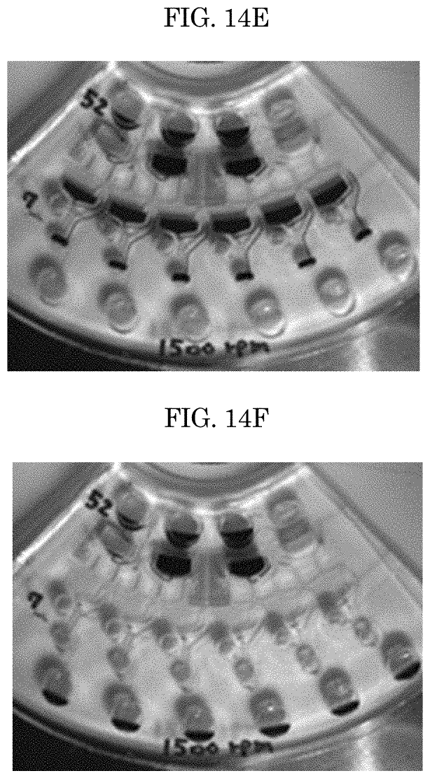

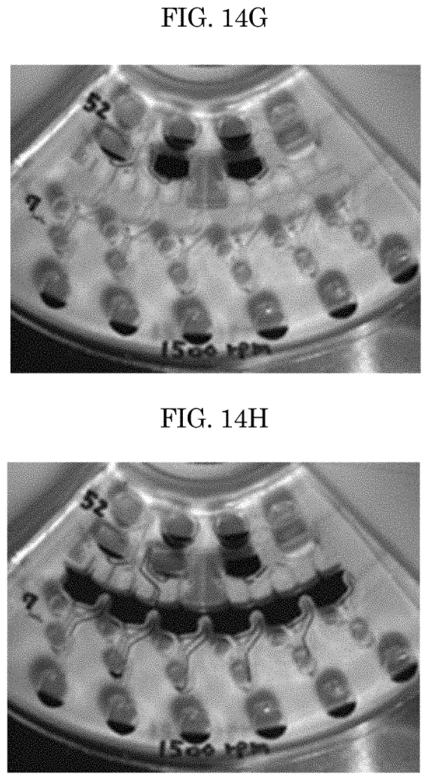

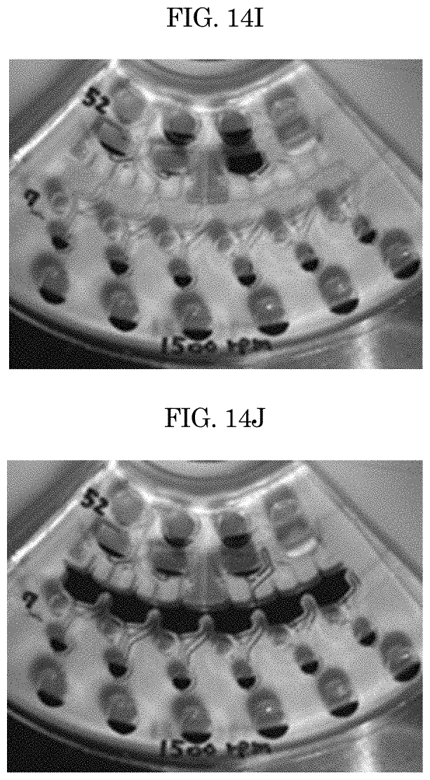

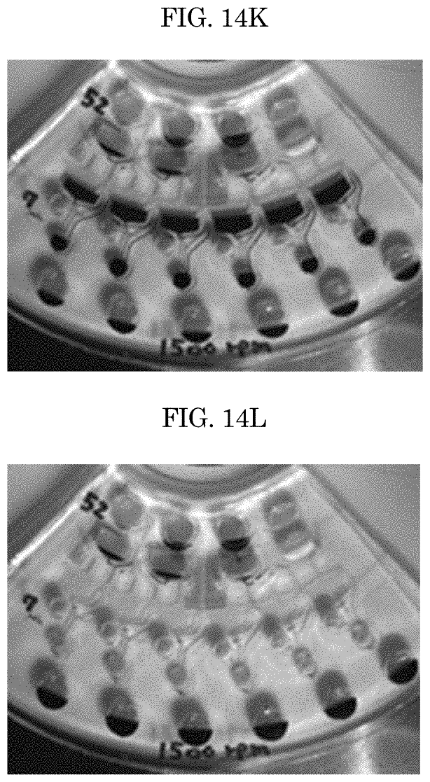

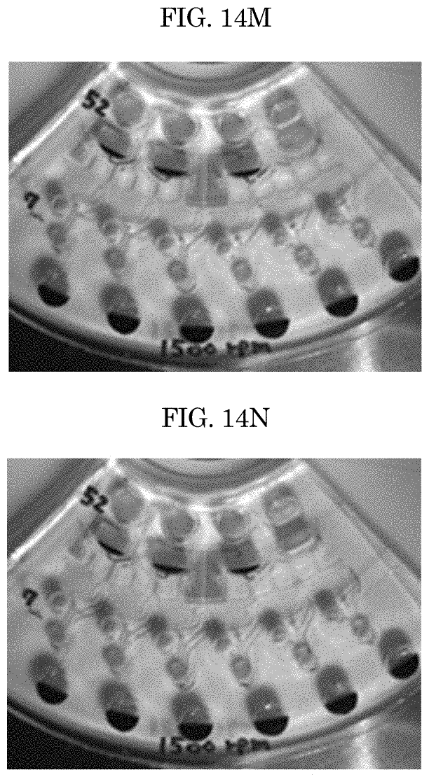

FIGS. 14A to 14O are still images included in video data obtained by shooting movement of each fluid when the test apparatus 30 illustrated FIGS. 12 and 13A to 13O actually performed a test. Based on these results, the test apparatus 30 can easily test a plurality of test objects using a dispensing apparatus.

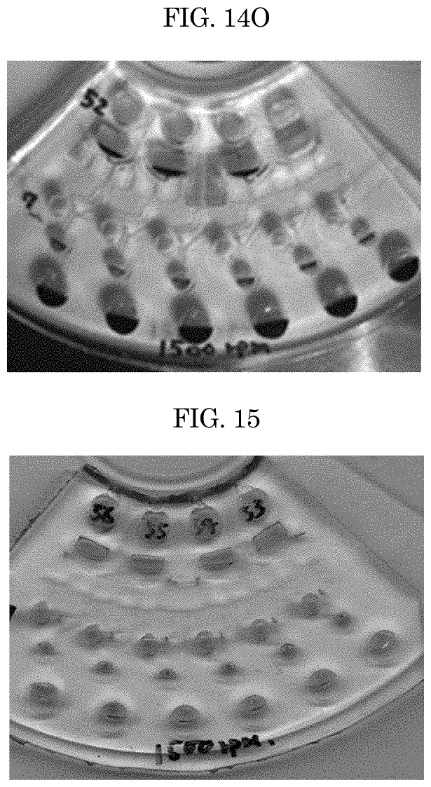

FIG. 15 is a photograph illustrating a scanned image of the test apparatus 30 which has been prepared for detection of a protein in the sequence of events as illustrated in FIGS. 14A to 14O.

It can be seen that the color is developed darker in the order from the reaction chamber 382a to the reaction chamber 382f as illustrated in FIG. 15 because the concentration of the protein used in the test was higher in the order from the sample solution S1 to the sample solution S6.

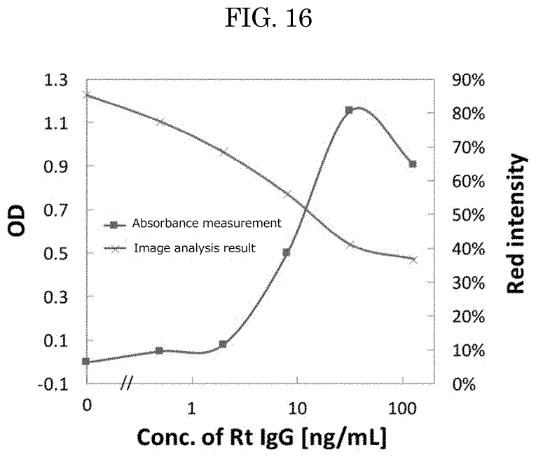

FIG. 16 is a graph illustrating analysis results for amounts of the protein. A line plotted with “x” in FIG. 16 denotes a signal intensity of R among RGB information obtained from image analysis of the scanned image illustrated in FIG. 15. A line plotted with “▪” in FIG. 16 denotes measurement results for optical densities (OD values) in the reaction chamber of the test apparatus 30 measured by MULTISKAN GO available from Thermo fisher scientific.

As illustrated in FIG. 16, it can be seen that the signal intensity of R is decreased because the color developing substrate develops the bluer color as the concentration of the protein increases. It can also been seen that the OD value is higher as the concentration of the protein increases. Based on these results, the test apparatus 30 can be used to detect a protein.

As described above, the test apparatus can easily test a plurality of test objects using a dispensing apparatus.

In the present example, the sample solutions contained varying amounts of a protein, but are not limited thereto. The sample solutions may be identical to each other.

Moreover, in conventional tests, the test should be performed under the same environmental conditions as those used for generating a standard curve because analysis results are evaluated by collating measured numerical values with the standard curve which has been previously generated. However, when the test apparatus of the present invention is used, the standard curve can be generated at the same time as each measurement, which can improve reliability of a test.

Embodiments of the present invention are, for example, as follows.

<1> A dispensing apparatus including:
a plurality of first accommodating units which are formed in communication with each other and which are configured to be able to divide and accommodate a fluid sample transferred by external force;
a plurality of second accommodating units each configured to accommodate the fluid sample which has been divided into the plurality of the first accommodating units; and
transfer means each configured to transfer the fluid sample, which has been accommodated in the plurality of the first accommodating units, to the second accommodating units.
   <2> The dispensing apparatus according to <1>,
   wherein the plurality of the first accommodating units have volumes equal to each other.
   <3> The dispensing apparatus according to <1> or <2>,
   wherein the transfer means include:
pressing units configured to apply pressure equal to or greater than a predetermined value to the fluid sample which has been accommodated in the first accommodating units; and
flow channels configured to transfer the fluid sample from the plurality of the first accommodating units to the plurality of the second accommodating units, when the pressure equal to or greater than the predetermined value is applied to the fluid sample accommodated in the plurality of the first accommodating units.
   <4> The dispensing apparatus according to <3>,
   wherein the pressing units are arranged in the first accommodating units at a side opposite to a direction in which the external force is applied and are configured to be able to accommodate the fluid sample.
   <5> The dispensing apparatus according to any one of <1> to <4>,
   wherein the dispensing apparatus is placed on a rotatable rotator.
   <6> A test apparatus including:
a dispensing section including the dispensing apparatus according to any one of <1> to <5>; and
a testing section configured to test a plurality of test objects using a fluid sample which has been dispensed by the dispensing section.
   <7> The test apparatus according to <6>,
   wherein the testing section is configured to test the plurality of the test objects in a state in which same external force as the external force applied to the dispensing section is applied.
   <8> A dispensing device including:
an introduction unit configured to be introduced with a fluid sample;
a connected container including a plurality of dividing containers which are formed in communication with each other and which are configured to be able to divide and accommodate the fluid sample transferred by external force;
a group of accommodating containers including a plurality of accommodating containers each configured to accommodate the fluid sample which has been divided in the connected container; and
transfer mechanisms each configured to transfer the fluid sample, which has been accommodated and then divided in the connected container, to the group of accommodating containers.
   <9> A dispensing method including:
firstly accommodating a fluid sample into a plurality of first accommodating units which are formed in communication with each other and which are configured to be able to divide and accommodate the fluid sample transferred by external force;
secondly accommodating the fluid sample, which has been divided and accommodated in the plurality of the first accommodating units, in a plurality of second accommodating units each configured to accommodate the fluid sample; and
transferring the fluid sample, which has been accommodated in each of the plurality of the first accommodating units, to each of the second accommodating units.
   <10> The dispensing method according to <9>,
   wherein the fluid sample is transferred by
applying pressure equal to or greater than a predetermined value to the fluid sample which has been accommodated in the first accommodating units; and
transferring the fluid sample from the plurality of the first accommodating units configured to firstly accommodate the fluid sample to the plurality of the second accommodating units configured to secondly accommodate the fluid sample, when the pressure equal to or greater than the predetermined value is applied to the fluid sample accommodated in the plurality of the first accommodating units.
   <11> A test method including;
firstly accommodating a fluid sample into a plurality of first accommodating units which are formed in communication with each other and which are configured to be able to divide and accommodate the fluid sample transferred by external force;
secondly accommodating the fluid sample, which has been divided and accommodated in the plurality of the first accommodating units, in a plurality of second accommodating units each configured to accommodate the fluid sample;
transferring the fluid sample, which has been accommodated in each of the plurality of the first accommodating units, to each of the second accommodating units; and
testing a plurality of test objects using the fluid sample which has been accommodated in the second accommodating units.
   <12> The test method according to <11>,
   wherein the plurality of the test objects are tested in a state in which same external force as the external force applied during dispensing is applied.

The dispensing apparatus according to any one of <1> to <5>, the test apparatus according to <6> or <7>, the dispensing device according to <8>, the dispensing method according to <9> or <10>, and the test method according to <11> or <12> can solve the above existing problems and achieve the objects of the present invention.

When using, as a pressing unit, a pressing flow channel which is connected to a connected container and arranged to extend to the upstream side, the pressing flow channel may be formed, for example, as illustrated in FIG. 1 or 12. That is, each of the pressing flow channels (160a to 160e) is connected at one end thereof (one end of the pressing flow channel) to each of the first accommodating units (dividing chambers 150a to 150e) and is arranged so as to extend from each of the dividing chambers to a side opposite to a direction in which external force is applied. In other words, each of the pressing flow channels is arranged so as to extend from each of the dividing chambers to a rotation axis position O side or so as to extend from each of the dividing chambers to a direction getting closer to the rotation axis position O as seen from the rotation axis position O. Moreover, vents (192a to 192e) may be disposed at the other ends of the pressing flow channels.

Thus, water head pressure within the pressing flow channels 160a to 160e increases as the centrifugal force CF continues to be applied to the dispensing apparatus 10, the connected chamber 150 is filled with fluid sample A, and then the fluid sample A flows into the pressing flow channels 160a to 160e. Thus-increased water head pressure allows the pressing flow channels 160a to 160e to function to press the fluid sample A contained in the connected chamber 150.

In the case of the structure in which the fluid sample flowing into a sealed container allows a pressing medium, which is at least one of a liquid and a gas and is incompatible with the fluid sample, to transfer and then the fluid sample contained in the connected container is pressed by the action of pressure of the pressing medium, the air can be suitably used as the pressing medium.

When the air is used as the pressing medium, pressed air may be allowed to flow into the above-mentioned pressing flow channel. In such a case, a mechanism for pressing the air medium may be connected to the flow channel after the flow channels is arranged so as to extend from each of the dividing chambers to a side opposite to a direction in which external force is applied. The mechanism for pressing the air may be formed on a microdevice or may be connected to an external pressing mechanism.

Note that, in FIG. 12, the connected chamber 350 includes the dividing chambers 350a to 350f. One ends of the pressing flow channels 360a to 360f are connected to the dividing chambers 350a to 350f, respectively, and the other ends of the pressing flow channels 360a, 360c, 360d, and 360f among the pressing flow channels are connected to vents 392a, 360c, 360d, and 360f, respectively. Note that, the other end of each of the pressing flow channels 360b and 360e is arranged so that the pressing flow channel extends to an end surface at the rotation axis position (O) side of the test apparatus 30.

### DESCRIPTION OF THE REFERENCE NUMERAL

10 dispensing apparatus
30 test apparatus
110 first reservoir
130 second reservoir
150 connected chamber (plurality of first accommodating units)
150a to 150e dividing chambers (first accommodating units)
160a to 160e pressing flow channels (pressing unit of transfer means)
170a to 170e siphon-structured flow channels (flow channel of transfer means)
180a to 180e accommodating chambers (second accommodating units)

1. A dispensing apparatus comprising:
a plurality of first accommodating units which are formed in communication with each other and which are configured to be able to divide and accommodate a fluid sample transferred by external force;
a plurality of second accommodating units each configured to accommodate the fluid sample which has been divided into the plurality of the first accommodating units; and
transfer means each configured to transfer the fluid sample, which has been accommodated in the plurality of the first accommodating units, to the second accommodating units,
wherein the transfer means comprise:
pressing units configured to apply pressure equal to or greater than a predetermined value to the fluid sample which has been accommodated in the first accommodating units; and
flow channels configured to transfer the fluid sample from the plurality of the first accommodating units to the plurality of the second accommodating units, when the pressure equal to or greater than the predetermined value is applied to the fluid sample accommodated in the plurality of the first accommodating units, and
wherein the pressing units are arranged in the first accommodating units at a side opposite to a direction in which the external force is applied and are configured to be able to accommodate the fluid sample.

2. The dispensing apparatus according to claim 1,
wherein the plurality of the first accommodating units have volumes equal to each other.

3. (canceled)

4. (canceled)

5. The dispensing apparatus according to claim 1,
wherein the pressing units are pressing flow channels.

6. The dispensing apparatus according to claim 5,
wherein the pressing flow channels are flow channels each of which is connected at one end thereof to each of the first accommodating units and is arranged so as to extend from each of the first accommodating units to a side opposite to a direction in which the external force is applied.

7. The dispensing apparatus according to claim 6,
wherein at least one of other ends of the pressing flow channels is provided with a vent.

8. The dispensing apparatus according to claim 1,
wherein the dispensing apparatus is placed on a rotatable rotator.

9. A test apparatus comprising:
a dispensing section including the dispensing apparatus according to claim 1; and
a testing section configured to test a plurality of test objects using the fluid sample which has been dispensed by the dispensing section.

10. The test apparatus according to claim 9,
wherein the testing section is configured to test the plurality of the test objects in a state in which same external force as the external force applied to the dispensing section is applied.

11. A dispensing device comprising:
an introduction unit configured to be introduced with a fluid sample;
a connected container including a plurality of dividing containers which are formed in communication with each other and which are configured to be able to divide and accommodate the fluid sample transferred by external force;
a group of accommodating containers including a plurality of accommodating containers each configured to accommodate the fluid sample which has been divided in the connected container; and
transfer mechanisms each configured to transfer the fluid sample, which has been accommodated and then divided in the connected container, to the group of accommodating containers,
wherein the transfer mechanisms comprise:
pressing units configured to apply pressure equal to or greater than a predetermined value to the fluid sample which has been accommodated in the plurality of the dividing containers in the connected container; and
flow channels configured to transfer the fluid sample from the plurality of the dividing containers to the plurality of the accommodating containers in the group of the accommodating containers, when the pressure equal to or greater than the predetermined value is applied to the fluid sample accommodated in the plurality of the dividing containers, and
wherein the pressing units are arranged in the connected container at a side opposite to a direction in which the external force is applied and are configured to be able to accommodate the fluid sample.

12. A dispensing method comprising:
firstly accommodating a fluid sample in a plurality of first accommodating units which are formed in communication with each other and which are configured to be able to divide and accommodate the fluid sample transferred by external force;
secondly accommodating the fluid sample, which has been divided and accommodated in the plurality of the first accommodating units, in a plurality of second accommodating units each configured to accommodate the fluid sample; and
transferring the fluid sample, which has been accommodated in each of the plurality of the first accommodating units, to each of the second accommodating units,
wherein the transferring is performed using transfer means,
wherein the transfer means comprise:
pressing units configured to apply pressure equal to or greater than a predetermined value to the fluid sample which has been accommodated in the first accommodating units; and
flow channels configured to transfer the fluid sample from the plurality of the first accommodating units to the plurality of the second accommodating units, when the pressure equal to or greater than the predetermined value is applied to the fluid sample accommodated in the plurality of the first accommodating units, and
wherein the pressing units are arranged in the first accommodating units at a side opposite to a direction in which the external force is applied and are configured to be able to accommodate the fluid sample.

13. A test method comprising using the test apparatus according to claim 9.
